(19) United States
(12) Patent Application Publication
(10) Pub. No.: US 2022/0148437 A1
(43) Pub. Date: May 12, 2022

(54) Systems and Methods for Facilitating Communication Between Aerial Computing Devices

(71) Applicant: Joby Aero, Inc., Santa Cruz, CA (US)

(72) Inventors: Eric Richard Mueller, San Francisco, CA (US); Christabelle Simone Juliette Bosson, Mountain View, CA (US); Bogu Wei, Santa Clara, CA (US); Gregory Mark Gerard Belaus, San Francisco, CA (US); Kirill Zaskalkin, San Francisco, CA (US)

(21) Appl. No.: 17/523,271

(22) Filed: Nov. 10, 2021

Related U.S. Application Data
(60) Provisional application No. 63/111,811, filed on Nov. 10, 2020.

(51) Int. Cl. G08G 5/00; B64C 39/02

(52) U.S. Cl. CPC G08G 5/003; B64C 2201/12; G08G 5/0008; B64C 39/024

(57) ABSTRACT

Systems and methods for facilitating communication between a number of different computing devices are provided. A service entity that provides a multi-modal transportation service can collaborate with a number of different devices via a vehicle integration interface over a number of different frequencies or networks. The vehicle integration interface includes a number of endpoints. Each endpoint corresponds to a device type associated with a number of devices operated according to a unique protocol. The service entity obtains a communication or provides a message to a respective device via a respective endpoint of the vehicle integration interface. The service entity determines a device type associated with a received communication based on a respective endpoint and translates the communication based on the device type. The translated communication is aggregated with information received from a number of different devices configured to operate and communicate according to a number of different protocols.

### RELATED APPLICATIONS

This application claims priority to and the benefit of U.S. Provisional Patent Application No. 63/111,811, filed Nov. 10, 2020, which is hereby incorporated by reference in its entirety.

### FIELD

The present disclosure relates generally to facilitating multi-modal transportation services for riders. More particularly, the present disclosure relates to systems and methods for facilitating flight schedules adverse to aerial preferences.

### BACKGROUND

A wide variety of modes of transport are available within cities. For example, people can walk, ride a bike, drive a car, take public transit, or use a ride sharing service. As population densities and demand for land increase, however, many cities are experiencing problems with traffic congestion and the associated pollution. Consequently, there is a need to expand the available modes of transport in ways that can reduce the amount of traffic without requiring the use of large amounts of land.

### SUMMARY

Aspects and advantages of embodiments of the present disclosure will be set forth in part in the following description, or can be learned from the description, or can be learned through practice of the embodiments.

An example aspect of the present disclosure is directed to a computer-implemented method. The method includes obtaining, by the computing system comprising one or more computing devices, a communication associated with an aerial vehicle via an endpoint of a plurality of endpoints communicatively connected to a vehicle integration interface. The communication includes received telemetry data comprising telemetry data for the aerial vehicle formatted according to an aerial device format. The method includes identifying, by the computing system, an aerial device format corresponding to the communication based, at least in part, on the endpoint. The method includes generating, by the computing system, formatted telemetry data based, at least in part, on the received telemetry data and the device specific format. The formatted telemetry data includes the telemetry data for the aerial vehicle formatted according to a different format than the device specific format. The method includes initiating, by the computing system, one or more vehicle actions for the aerial vehicle based, at least in part, on the formatted telemetry data.

In some implementations, the method further includes updating, by the computing system, a vehicle model corresponding to the aerial vehicle based, at least in part, on the formatted telemetry data. The vehicle model can include formatted vehicle data for the aerial vehicle formatted according to the different format. The vehicle model can be indicative of a vehicle state for an aerial vehicle. The vehicle state can be indicative of a location, energy, route, health, or configuration of the aerial vehicle. The telemetry data can be indicative of a location update, a route update, a power update, a health update, or a configuration update for the aerial vehicle. The location update can be indicative of the current location of the aerial vehicle. In some implementations, the method can include updating, by the computing system, the location of the vehicle state based, at least in part, on the current location of the aerial vehicle.

In some implementations, the communication can be obtained from an aerial vehicle device of a plurality of different aerial vehicle devices. The aerial device format can be a data format used by the aerial vehicle device. The different format can correspond to a data format used by a service entity associated with the plurality of aerial vehicle devices. The aerial device format can be one of a plurality of different aerial device formats. Each of the plurality of aerial vehicle devices are associated with a respective aerial device format of the plurality of aerial device formats. The service entity can be configured to communicate with the plurality of aerial vehicle devices to facilitate a multi-modal ride-sharing network.

The vehicle model can be one of a plurality of vehicle models. Each of the plurality of vehicle models can correspond to a respective aerial vehicle utilized to facilitate the multi-modal ride-sharing network. The communication can include a received vehicle identifier. Updating the vehicle model associated with the aerial vehicle can include generating, by the computing system, a formatted vehicle identifier based, at least in part, on the received vehicle identifier and the device specific format. The method can include identifying, by the computing system, the vehicle model from the plurality of vehicle models based, at least in part, on the formatted vehicle identifier.

In some implementations, generating the formatted telemetry data based, at least in part, on the received telemetry data and the aerial vehicle device can include determining, by the computing system, a data conversion function for the received telemetry data based, at least in part, on the device specific format and generating, by the computing system, the formatted telemetry data based, at least in part, on the conversion function.

Another example aspect of the present disclosure is directed to one or more tangible, non-transitory computer-readable media storing computer-readable instructions that when executed by one or more processors cause the one or more processors to perform operations. The operations can include obtaining routing data for an aerial vehicle associated with an aerial vehicle device. The routing data can be formatted according to a device agnostic format corresponding to a service entity associated with one or more aerial vehicle devices. The operations can include generating a routing request for the aerial vehicle based, at least in part, on the aerial vehicle device and the routing data. The routing request can include the routing data formatted according to an aerial device format corresponding to the aerial vehicle device. The operations can include determining an endpoint corresponding to the aerial vehicle device. The endpoint can be one of a plurality of endpoints of a vehicle integration interface associated with the service entity. The vehicle integration interface can be configured to connect with the plurality of endpoints. And, the operations can include providing, via the endpoint of the vehicle integration interface, the routing request to the aerial vehicle device.

Yet another example aspect of the present disclosure is directed to a computing system including one or more processors; and one or more tangible, non-transitory, computer readable media that store instructions that when executed by the one or more processors cause the computing system to perform operations. The operations can include obtaining routing data for an aerial vehicle associated with an aerial vehicle device. The operations can include generating a routing request for the aerial vehicle based, at least in part, on the aerial vehicle device and the routing data. The operations can include determining an endpoint corresponding to the aerial vehicle device. The endpoint can be one of a plurality of endpoints of a vehicle integration interface associated with a service entity. The vehicle integration interface can be configured to connect with the plurality of endpoints. And, the operations can include providing, via the endpoint of the vehicle integration interface, the routing request to the aerial vehicle device.

Other aspects of the present disclosure are directed to various systems, apparatuses, non-transitory computer-readable media, user interfaces, and electronic devices. These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system according to example embodiments of the present disclosure;

FIG. 2 depicts a graphical diagram of an example transportation node according to example embodiments of the present disclosure;

FIG. 3 depicts a graphical diagram of an example set of flight plans between an example set of transportation nodes according to example embodiments of the present disclosure;

FIG. 4 depicts an example vehicle provider ecosystem according to example embodiments of the present disclosure;

FIG. 5 depicts a graphical diagram of an example multi-modal transportation service itinerary according to example embodiments of the present disclosure;

FIG. 6 depicts an example vehicle integration interface system according to example embodiments of the present disclosure;

FIG. 7 depicts an example communication data flow diagram according to example embodiments of the present disclosure;

FIG. 8 depicts an example messaging queue process according to example embodiments of the present disclosure;

FIG. 9 depicts an end-to-end communication data flow diagram 900 according to example embodiments of the present disclosure;

FIG. 10 depicts a flow chart diagram for an example method of obtaining telemetry data from an aerial vehicle device according to example embodiments of the present disclosure;

FIG. 11 depicts a flow chart diagram of an example method providing a routing request to an aerial vehicle device according to example embodiments of the present disclosure; and

FIG. 12 depicts a block diagram of an example computing system according to example embodiments of the present disclosure.

### DETAILED DESCRIPTION

Example aspects of the present disclosure are directed to improved interfaces between a service entity computing system and aerial vehicle devices. For instance, the present disclosure describes a vehicle integration interface configured to proxy messages between a service entity that provides a multi-modal transportation service and multiple different aerial vehicle devices utilized to provide the multi-modal transportation service. For instance, a service entity can manage, coordinate, and/or otherwise interact with a plurality of different types of vehicles to provide services to a plurality of riders via a transportation platform. A service entity computing system associated with the service entity (e.g., an operations system, etc.) can obtain data indicative of a service request from one or more riders and generate one or more multi-modal transportation itineraries (e.g., rider itinerary, ground itinerary, flight itinerary, etc.) to facilitate transporting the rider from the origin location to the destination location. The multi-modal transportation itinerary can include at least two types of transportation such as, for example, a ground-based vehicle transportation and an aerial-based vehicle transportation. For example, the itinerary can include three legs: a first leg (e.g., a first ground portion including one or more ground-based modes of transportation) that includes a ground-based vehicle transporting a rider (or the rider providing their own transportation, e.g., walking or biking) from the origin location (e.g., a home, etc.) to a first aerial transportation facility; a second leg (e.g., one or more aerial portions) that includes an aircraft transporting the rider from the first aerial transportation facility to a second aerial transportation facility; and a third leg (e.g., a second ground portion including one or more ground-based modes of transportation) that includes another ground-based vehicle transporting the rider (or the rider providing their own transportation) from the second aerial transportation facility to the destination location (e.g., a conference center).

The service entity computing system can include a number of backend software services (e.g., routing services, vehicle management services, etc.) to help facilitate the aerial portion of the multi-modal transportation services. To do so, the service entity computing system (e.g., one or more service(s) thereof) can communicate (e.g., receive updated vehicle information, provide vehicle messages such as a vehicle routing request, etc.) with one or more aerial vehicle devices (e.g., a vehicle computing system, an operator device, a navigation device, etc.) during, before, and/or after an aerial portion of a multi-modal transportation itinerary.

The aerial vehicle devices can include a number of different devices configured to communicate using one or more different data formats (e.g., different syntaxes, messaging formats, communication protocols, etc.). At times, the different data format(s) can differ from a data format used by the service entity computing system.

To account for the number of unique data formats, the service entity computing system can include a vehicle integration interface configured to proxy a number of messages received and/or transmitted to each of the aerial vehicle device(s). The service entity computing system can obtain a communication (e.g., via a virtual endpoint of the vehicle integration interface) from an aerial vehicle device, identify a data format corresponding to the communication (e.g., based on the endpoint of the vehicle integration interface), translate the communication to a service entity readable format based on the identified data format (e.g., a data format utilized by the aerial vehicle device), and update a vehicle model corresponding to an aerial vehicle associated with the communication.

Similarly, the service entity computing system can generate a vehicle message (e.g., a route request, etc.) for an aerial vehicle, translate the message to a device specific format corresponding to an aerial vehicle device (e.g., onboard vehicle computing system, operator device, etc.) associated with the aerial vehicle, and provide the translated message to the aerial vehicle device (e.g., via an endpoint of the vehicle integration interface that corresponds to the device). The message can be generated based on a current state (e.g., landing, inflight, parked, current heading, speed, location, energy level, etc.) of the aerial vehicle as represented by a vehicle model maintained by the service entity computing system. The vehicle model can accurately represent the current state of the vehicle by aggregating data received (e.g., via the vehicle integration interface) from a number of different devices associated with the aerial vehicle.

In this manner, the vehicle integration interface can enable a computing system to efficiently receive, identify, and aggregate data from a plurality of disparate devices associated with unique messaging, communication, and/or data formats. By maintaining a vehicle model indicative of the aggregated data in a common data format, the computing system can make informed transportation decisions for aerial vehicles based on holistic, current, and dynamically updated vehicle information. In this way, the vehicle integration interface provides an improvement to the functioning of computing technology (e.g., telecommunication technology, aircraft computing system technology, etc.) by enabling the seamless communication between a number of aerial devices operated according to a plurality of distinct computing languages, unique communication protocols, data formats, and/or messaging formats.

More particularly, a service entity can be associated with a service entity computing system (e.g., a cloud-based operations computing system, etc.) that is configured to manage, coordinate, simulate, and/or dynamically adjust a multi-modal transportation service via a transportation platform. The multi-modal transportation service can include a plurality of transportation legs, one of which (e.g., a second transportation leg) can include an aerial transportation of a rider. For example, the service entity computing system can obtain a request for a transportation service. The request for the transportation service can include at least a request for an aerial transport of a rider of the transportation platform. To facilitate the transportation service, the service entity computing system can create an end-to-end multi-modal itinerary that includes two or more transportation legs that include travel via two or more different transportation modalities such as, for example: cars, light electric vehicles (e.g., electric bicycles or scooters), buses, trains, aircraft, watercraft, and/or other transportation modalities. Example aircrafts can include helicopters and/or other vertical take-off and landing aircraft (VTOL) such as electric vertical take-off and landing aircraft (eVTOL).

The vehicles can include non-autonomous, semi-autonomous, and/or fully-autonomous vehicles provided and/or maintained by one or more vehicle provider(s). For instance, each vehicle can include a service entity vehicle provided and/or maintained by a service entity vehicle provider associated with the service entity computing system and/or a third-party vehicle provided and/or maintained by a third-party vehicle provider associated with a vehicle provider computing system. As described herein, the service entity computing system can provide cross-platform support to third-party vehicle providers and/or third party vehicles thereof.

The service entity computing system can perform one or more algorithms to generate the end-to-end multi-modal itinerary for a rider. As an example, the service entity computing system can sequentially analyze and identify potential transportation legs for each different available transportation modality. For example, a most critical, challenging, and/or supply-constrained transportation leg can be identified first and then the remainder of the itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first).

A transportation modality (e.g., a flight-based modality) can operate according to or within a fixed transportation infrastructure in which the ability of riders to embark and disembark vehicles is constrained to a defined set of transportation nodes. For example, the fixed transportation infrastructure can include a plurality of aerial vehicles (e.g., service entity vehicles, third-party vehicles, etc.) that operate within a ride sharing network facilitated by the service entity computing system. The aerial vehicle(s) can be constrained to load and unload riders only at a defined set of physical take-off and/or landing areas which may in some instances be referred to as aerial transportation facilities. Each aerial transportation facility can include one or more landing pads and/or other infrastructure to enable riders to safely embark or disembark from aerial vehicles. Aerial transportation facilities can also include charging equipment, cooling equipment, refueling equipment, and/or other infrastructure for enabling aircraft operation and/or maintenance.

The service entity computing system can include and/or be associated with a number of subsystems (e.g., world state system, forecasting system, optimization system, matching and fulfillment system, etc.) configured to provide a plurality of backend services to facilitate a transportation service. By way of example, an optimization/planning system can provide a backend itinerary service to generate one or more multi-modal transportation itineraries for a rider. In addition, the optimization/planning system can provide a backend routing service to determine one or more flight plans, routes, sky lanes, etc. for vehicles associated with a transportation service. As another example, the service entity computing system can include a world state system, a forecasting system, and/or any other system capable of facilitating a transportation service. The world state system, for example, can operate a state monitoring system to maintain data descriptive of a current state of the world (e.g., a real-time transportation demand, flight assignments, operational statuses and locations of a plurality of vehicles, etc.). For instance, the world state system can be configured to obtain world state data through communication (e.g., via a vehicle integration interface) with one or more vehicles, aerial vehicle providers, and/or any other aerial vehicle device associated with the service entity. As another example, a forecasting system can operate a forecasting service to generate predictions of transportation demand, weather forecasts, and/or any other future looking data helpful for completing a transportation service.

The service entity computing system can provide access to one or more services of the service entity to systems (e.g., third-party vehicle computing systems, third-party air traffic control systems, etc.) associated with service entity and/or device(s) thereof. For example, the service entity computing system (and/or one or services thereof) can communicate with the aerial vehicle(s) (e.g., service entity, third-party, etc.) to obtain information from the vehicles and/or provide one or more message(s) such as, for example, requests for vehicle actions in accordance with a multi-modal transportation network.

By way of example, each aerial vehicle (e.g., service entity, third-party, etc.) can be associated with one or more aerial vehicle device(s). The aerial vehicle device(s) can include a plurality of different devices associated with the operations of a respective aerial vehicle. For instance, the device(s) can include a device associated with the service entity computing system (e.g., for service entity vehicles), a device associated with the vehicle provider computing system (e.g., for third-party vehicles), an operator device (e.g., mobile phone, etc.) associated with an operator of the aerial vehicle, a navigational device (e.g., avionic navigation devices manufactured by various manufacturers) onboard the aerial vehicle, a device associate with a vehicle computing system (e.g., an onboard computing system of the aerial vehicle, a commercial drone device, a hobby drone device, etc.) onboard the aerial vehicle, and/or any other device associated with the respective aerial vehicle. The service entity computing system (and/or one or services thereof) can communicate with the aerial vehicle device(s) to interact (e.g., assign a flight, obtain a current location, etc.) with the respective aerial vehicles.

In this manner, the service entity can be configured to communicate with devices of various device providers (e.g., vehicle device providers, navigational device providers, user device providers, etc.) to facilitate the multi-modal ride-sharing network. The device providers can include any entity associated with the operation of an aerial vehicle. For instance, the device providers can be associated with the one or more aerial vehicle device(s) (e.g., aerial vehicle provider device(s), operator device(s), onboard vehicle device(s), navigation device(s), etc.) associated with service entity and/or third party aerial vehicle(s). The respective device provider, for example, can include one or more manufacturers (e.g., vehicle manufacturers, device manufacturers, onboard systems manufacturers, etc.) and/or providers of the subset of aerial vehicle device(s). By way of example, the subset of aerial vehicle device(s) can include one or more navigational device(s) manufactured by the respective device provider. As another example, the subset of aerial vehicle device(s) can include one or more vehicle computing devices installed, manufactured, and/or maintained by the respective device provider (e.g., service entity, third-party entity, etc.). For example, the respective device provider can include a third-party vehicle provider and/or a service entity vehicle provider associated with the vehicle computing device(s). As yet another example, the subset of aerial vehicle device(s) can include device(s) associated with a respective device type of the one or more type(s) (e.g., navigation types, commercial drone types, hobby drone types, etc.). Each device type can be associated with one or more communication protocols, data formats, message formats, etc. for device(s) of the respective device type.

The vehicle integration interface can include and/or have access to an application programming interface (API) platform that can facilitate communication between the service entity infrastructure (e.g., the services of the service entity computing system, etc.) and the aerial vehicle device(s) (e.g., device(s) associated with aerial vehicle(s), etc.). The API platform can include one or more functional calls to the backend services of the service entity computing system. By way of example, the one or more functional calls can be configured to communicate a request and/or data between one or more subsystems (e.g., world state system, forecasting system, optimization/planning system, etc.) of the service entity computing system and the aerial vehicle device(s). In this way, backend services of the service entity can interact, via the vehicle integration interface, with aerial vehicle device(s) associated with a plurality of aerial vehicles configured to provide one or more aerial transportation services for a multi-modal ride sharing platform.

More particularly, the vehicle integration interface can include a plurality of virtual endpoints associated with the aerial vehicle device(s). An endpoint can be any virtual interface between an end point of the vehicle integration interface and one or more of the aerial vehicle device(s). For example, each aerial vehicle device can be associated with a corresponding endpoint of the plurality of endpoints. An endpoint, for example, can include a uniform resource locator corresponding to at least one aerial vehicle device. The corresponding endpoint for a respective aerial vehicle device can identify a connection (e.g., network connection, gateway device, a series of protocols, a frequency, etc.) with the respective aerial vehicle device. For example, the service entity computing system can provide information (e.g., a communication, message, routing request, etc.) to the respective aerial vehicle device via the corresponding endpoint of the vehicle integration interface. In addition, or alternatively, the respective aerial vehicle device can provide information (e.g., telemetry data, vehicle data, etc.) to the service entity computing system via the corresponding endpoint of the vehicle integration interface. In some implementations, each endpoint of the vehicle integration interface can facilitate communication between the service entity computing system and a subset of the aerial vehicle device(s) that are associated with a respective device provider and/or device type.

The device provider(s) and/or device type(s) (and/or the associated aerial vehicle device(s)) can be associated with one or more different aerial device format(s). For example, each of the aerial vehicle device(s) can be associated with a respective aerial device format of a plurality of aerial device formats. An aerial device format, for example, can include at least one of a plurality of different aerial device standards for transferring and/or manipulating data by an aerial vehicle device. For instance, each aerial device format can include a syntax, communication protocols, interface timing, data formats, messaging formats, etc. with which different aerial vehicle devices can communicate data. An aerial device format can define, for example, a specific message format, data representation formats, etc. for data transferring and/or processing by a respective aerial vehicle device. In some implementations, each aerial device format can be indicative of (and/or defined by) one or more computer programming languages (e.g., computer-readable instructions) and/or software that when compiled (e.g., by a respective compiler) can cause one or more processors of a respective aerial vehicle device to perform operations.

The service entity computing system can receive information associated with each of a plurality of associated vehicles from the aerial vehicle device(s) via the vehicle integration interface. For example, the service entity computing system can obtain a communication associated with an aerial vehicle via an endpoint of the plurality of endpoints of the vehicle integration interface. The communication can include device specific telemetry data, communication fields, and/or secondary vehicle information. The device specific information (e.g., telemetry data, communication fields, secondary vehicle information, etc.) can include information (e.g., telemetry data, communication fields, secondary vehicle information, etc.) formatted according to an aerial device format corresponding to the aerial vehicle device that provided the communication.

For example, the device specific telemetry data can include telemetry data for an aerial vehicle formatted according to an aerial device format corresponding to the aerial vehicle device that provided the communication. The telemetry data can be indicative of current vehicle information for an aerial vehicle. The telemetry data can include data indicative of an updated location, energy, route, health, and/or configuration of the aerial vehicle. For instance, the telemetry data can include location data (e.g., indicative of a current vehicle location), fleet management information (e.g., indicative of management assignments, tasks, etc. associated with the aerial vehicle), routing information (e.g., indicative of an update to a route with which the vehicle is currently and/or scheduled to travel), flight information (e.g., indicative of a current vertical/lateral aircraft state, etc.), energy information (e.g., indicative of current fuel/battery consumption, an update to the fuel/battery level, etc.), vehicle systems health reporting (e.g., indicative a of vehicle health state, etc.). The vehicle systems health reporting, for example, can be indicative of any abnormalities that can be associated with a potentially actionable event such as, for example, an engine temperature, speed, communication system interference, etc. In some implementations, the telemetry data can identify a current flight state representing the current stage (e.g., ground, takeoff, inflight, landing, etc.) of a flight. In addition, or alternatively, the telemetry data can include vehicle configuration data representing the mechanical configuration of one or more vehicle components such as, for example, a flaps position, landing gear position, engine throttle position, etc. This can include, for example, component sensor data configured to measure the position of the vehicle component(s).

The telemetry data can include data possessed by the avionics of an aerial vehicle. For instance, such data can include the current latitude, longitude, and/or navigation accuracy estimates and/or categories; altitude (e.g., a GNSS WGS84 and/or accuracy estimate, uncorrected and/or corrected pressure altitude, or an AGL altitude if measured directly along with an accuracy estimate); airspeed (e.g., indicated airspeed, equivalent airspeed, true airspeed, calibrated airspeed, etc.); groundspeed; heading and course (e.g., direction of aircraft nose and/or ground track velocity vector in degrees true, degrees magnetic, etc.); attitude; body-axis attitude rates; reference values of state parameters the flight control system is tracking (e.g., altitude, airspeed, heading, etc.); and/or an integrity, accuracy, and/or uncertainties of one or more position (e.g., latitude, longitude, etc.) measurements (e.g., navigation integrity category, natural areas code, source integrity level, etc. for global positioning system technology).

In addition, the telemetry data can include trajectory intent for the aerial vehicle. The trajectory intent, for example, can include data indicative of the intended path of flight for the aerial vehicle. The data can include a set of sequential four dimensional (e.g., latitude, longitude, altitude, time, etc.) trajectory points. In some implementations, the trajectory points can include planned/predicted state data at each point (e.g., velocities, attitudes, attitude rates, etc.). By way of example, the trajectory points can be calculated by defining a position/altitude of the aerial vehicle as an analytical function of time. In addition, or alternatively, the data indicative of the intended path of flight for the aerial vehicle can include a set of tactical instructions. The set of tactical instructions can include a dead-reckoning trajectory with a time and/or point in space (e.g., trajectory-change points) in which a new set of dead-reckoning constraints can apply (e.g., climb-to-and-maintain 3000 ft). In some implementations, the data can include the provisioning of a procedure (e.g., following an airspace “letter of agreement”) without a time-based prediction. In addition, or alternatively, the data can include a dead reckoning trajectory indicating that the aerial vehicle will continue to follow a given heading/course and vertical rate indefinitely.

In some implementations, the telemetry data can include airspace data. The airspace data can include information about the state of the airspace proximate to the aerial vehicle such as information from an ADS-B (e.g., ownership and other aircraft telemetry data); TIS-B (e.g., non-ADS-B out aircraft telemetry data); FIS-B; TCAS (e.g., targets, plus preventive and/or corrective alerts/maneuvers); weather and/or environmental sensing data (e.g., wind speed, temperature, pressure, humidity, turbulence, etc.); audio feed data from ATC VHF communication systems; and/or any other externally sensed data and/or associated sensor configuration information. In some implementations, the telemetry data can include aircraft systems data indicative of the configuration and state of the aerial vehicle such as, for example, an amount of fuel/charge remaining onboard, control-related data (e.g., throttle setting, flap configuration, engine RPMs, etc.) maintenance- or health-monitoring-related data, weight/balancing information, and/or any other internally sensed data and/or associated sensor configuration information.

The device specific secondary vehicle information can be indicative of secondary vehicle information associated with the aerial vehicle such as, for example, external sensor data indicative of one or more environmental conditions, internal sensor data indicative of one or more interior (e.g., vehicle cabin) conditions within a vehicle cabin of the aerial vehicle, payload data indicative of a weight carried beyond an aircraft empty mass associated with the aerial vehicle, and/or any other data associated the aerial vehicle and/or a transportation service. The payload data, for example, can be indicative of one or more passengers and/or cargo carried by the aerial vehicle. The device specific secondary vehicle information can be formatted according to the aerial device format corresponding to the aerial vehicle device that provided the communication.

The device specific communication field(s) can be indicative of one or more communication fields formatted according to the aerial device format corresponding to the aerial vehicle device that provided the communication. For example, the device specific communication field(s) can include a device specific vehicle identifier indicative of the aerial vehicle device. In addition, or alternatively, the device specific communication field(s) can include fields indicative of at least one of a message version, a message identifier (e.g., to identify duplicate messages, etc.), a message source (e.g., a device, such as the aerial vehicle device, that generated and/or provided the message, etc.), one or more timestamps (e.g., an expiration timestamp, collection timestamp, etc.), an operation identifier (e.g., identifying an operation (e.g., flight, route, route subroutine, etc.) associated with the communication), one or more priority(s), and/or any other field representing information associated with the aerial vehicle device.

For example, the communication field(s) can include timestamp(s). The timestamp(s) can include at least one of a sending timestamp indicative of a time at which the message was sent, a generation timestamp indicative of a time at which the message was delivered, etc. In addition, or alternatively, in some implementations, the timestamp(s) can include an expiration timestamp and/or a collection timestamp. The expiration timestamp can be indicative of a time at which the information provided by the communication is no longer valid. The collection timestamp can be indicative of a time at which the message was harvested.

In addition, the communication field(s) can include priority(s). The priority(s) can be indicative of an order in which the communication will be processed (e.g., by the vehicle integration interface). For example, the vehicle integration interface (and/or one or more endpoints thereof) can include one or more reception and/or transmission communication queue(s). The reception queue(s) can include one or more data structure(s) configured to receive and/or store a plurality of communications before the communications are processed by the vehicle integration interface. The reception queue(s) can include an endpoint reception queue corresponding to each endpoint of the vehicle integration system, a reception queue for one or more of the endpoints, and/or an overall reception queue for every communication received from each of the plurality of endpoints. The reception queue(s) can include one or more priority queue(s) in which the plurality of communications are ordered according to the priority(s) associated with each respective communication. In some implementations, a communication from the reception queue(s) can be processed based on the priority(s) of the communication and/or a pending time period. The priority(s), for example, can be determined by the aerial vehicle device (e.g., according to one or more priority standards) based on the contents (e.g., telemetry data, secondary vehicle information, communication fields) of the communication. In addition, or alternatively, the priority(s) can be determined based on the endpoint corresponding to the communication. In this manner, the vehicle integration interface can receive and/or process communication(s) in a certain order to avoid processing overload and prioritize the processing of certain information (e.g., safety related information, etc.).

The service entity computing system (e.g., the vehicle integration interface) can determine an aerial vehicle device corresponding to the communication based, at least in part, on an endpoint by which the communication was received. For example, as described herein, each endpoint of the vehicle integration interface can facilitate communication between the service entity computing system and a subset of the aerial vehicle device(s) that are associated with a respective device provider and/or device type. The service entity computing system can determine a device provider and/or type (and/or a corresponding aerial vehicle device) that is associated with the communication based on the subset of aerial vehicle device(s), device provider, and/or device type corresponding to the endpoint. In some implementations, for example where the communication includes a source field, the aerial vehicle device corresponding to the communication can be determined based on the endpoint and confirmed/validated by the source field. For example, the endpoint can identify the device provider/device type, the service computing system can use its knowledge of the device provider/device type to translate the communication to a service entity format, and the translated source field can be used to determine and/or verify the aerial vehicle device.

By way of example, the service entity computing system can generate a device agnostic communication. The device agnostic communication can include device agnostic telemetry data, secondary vehicle information, and/or communication fields. The service entity computing system can generate the device agnostic communication (e.g., device agnostic telemetry data, secondary vehicle information, communication fields, etc.) based on the device specific communication (e.g., device specific telemetry data, secondary vehicle information, communication fields, etc.) and the aerial vehicle device. The device agnostic telemetry data can include the telemetry data for the aerial vehicle in a different format than the device specific telemetry data. For example, the device agnostic telemetry data can include the telemetry data for the aerial vehicle formatted according to a format associated with a service entity that is generalized to each of the plurality of different data formats utilized by the plurality of aerial vehicle devices.

By way of example, the device specific telemetry data can include the telemetry data formatted according to an aerial device format corresponding to the aerial vehicle device. As described above, the aerial device format can include one of a plurality of different aerial device formats associated with a number of different aerial vehicle devices. The device agnostic telemetry data can include the telemetry data formatted according to a service entity format corresponding to the service entity associated with the number of different aerial vehicle devices. The service entity format can be different from one or more of the plurality of different aerial device formats associated with the number of different aerial vehicle devices.

The service entity computing system can translate the device specific telemetry data and/or other data (e.g., secondary vehicle information, communication fields, etc.) included in the communication to the service entity format based on the aerial vehicle device. For example, the vehicle integration interface can be configured to apply a data conversion function to the communication to translate the communication (e.g., telemetry data, secondary vehicle information, communication fields, etc.) from a device specific format to a device agnostic format. The service entity computing system (e.g., vehicle integration interface) can determine a data conversion function for the device specific telemetry data (and/or other components of the communication) based on the aerial vehicle device. The data conversion function can correspond to the aerial device format of the aerial vehicle device. The service entity computing system (e.g., vehicle integration interface) can generate the device agnostic communication (e.g., telemetry data, secondary vehicle information, communication fields, etc.) based on the conversion function. For example, the conversion function can be applied to the communication to convert the content of the communication to the service entity format.

The service entity computing system can update a vehicle model corresponding to the aerial vehicle associated with the aerial vehicle device based on the device agnostic telemetry data and/or other data included in the communication. For example, the vehicle model can include vehicle data for the aerial vehicle in a device agnostic format. The vehicle model can include one of a plurality of vehicle models. Each vehicle model can correspond to an aerial vehicle associated with the service entity (e.g., service entity vehicles, third-party vehicles, etc.). The service entity computing system can generate a device agnostic vehicle identifier (e.g., by applying the conversion function to the communication fields, etc.) based on the device specific vehicle identifier and the aerial vehicle device. The service entity computing system can identify the vehicle model based on the device agnostic vehicle identifier.

By way of example, the vehicle model can include one of a plurality of vehicle models. Each of the plurality of vehicle models can correspond to an aerial vehicle utilized to facilitate the multi-modal transportation network. The vehicle model can be indicative of a vehicle state for the aerial vehicle. The vehicle state can be indicative of a location, energy level, route, health, or configuration of the aerial vehicle. The telemetry data can be indicative of at least one of a location update, a route update, a power update, a health update, and/or a configuration update for the aerial vehicle. One or more of the updates indicated by the telemetry data can be applied to the vehicle model to update one or more of the aspects of the vehicle state.

The vehicle model can be updated based, at least in part, on telemetry data received, via the endpoints of the vehicle integration interface, from a plurality of aerial vehicle devices associated with a respective aerial vehicle. For example, the service entity computing system can receive communications (e.g., via the vehicle integration interface) from a plurality of different aerial vehicle devices (e.g., of different device provider/types, etc.) and update the vehicle model based on the content (e.g., telemetry data, secondary vehicle information, communication fields, etc.) of each of the communications. In this manner, the service entity computing system can aggregate data from a plurality of different devices (e.g., configured to communicate/operate according to a number of different formats, syntaxes, etc.) associated with an aerial vehicle to maintain a vehicle model representative of the current state of the aerial vehicle. As an example, the telemetry data can be indicative of a current location of the aerial vehicle as identified by one or more navigation device(s) (e.g., associated with a first device provider/type) onboard the aerial vehicle, an aerial vehicle computing system (e.g., associated with a second device provider/type), and/or any other device associated with the aerial vehicle. In such a case, the location of the vehicle model can be updated based on the current location of the aerial vehicle as identified by the plurality of different devices.

The service entity computing system can initiate one or more vehicle action(s) for the aerial vehicle based on the vehicle model. The vehicle action(s) can be initiated to facilitate a transportation service. For example, the vehicle action(s) can include at least one of a routing action, an assignment action, and/or a servicing action for the aerial vehicle. By way of example, the service entity can be configured to communicate (e.g., via the vehicle integration interface) with one or more aerial vehicle device(s) (e.g., configured to communicate/operate according to a number of different formats, syntaxes, etc.) to provide one or more messages to initiate a vehicle action. In this manner, the service entity computing system can utilize a vehicle integration interface to provide routing, servicing, and/or any other information associated with a transportation service to an aerial vehicle associated with one or more different communication standards.

More particularly, the service entity computing system can generate a message for an aerial vehicle that can be tailored for an aerial vehicle device associated with the aerial vehicle. The message can include a routing request. The message can be associated with one or more message types. The message types can include one or more informational message types, one or more routing request types, and/or any other type of message for facilitating an aerial transportation leg of a multi-modal transportation service. As an example, the informational message types can include aerial transportation service(s) data such as, for example, a passenger manifest, weather data, air space information (e.g., skylane traffic, etc.) and/or any other data associated with a transportation service. As another example, the route request types can include a route change type (e.g., a modification to a current or scheduled route), a contingency route type (e.g., a request to follow and/or alter contingency plan), a time of arrival type (e.g., a request to complete a flight by a time deadline), a procedure type (e.g., indicative of a route procedure), and/or a frequency type (e.g., a time period for sending and/or receiving telemetry data during the performance of a route). In some implementations, the message can include a route request that is at least one of the route request types.

The service entity computing system can generate a routing request based on routing data. For example, the service entity computing system can obtain routing data for an aerial vehicle associated with an aerial vehicle device. The routing data can include one or more aerial procedures. Each aerial procedure can include a route (and/or portion thereof), one or more altitude and/or speed constraints, and/or metadata indicative of suggested pilot behaviors for performing the aerial procedure. The aerial procedure(s) can include a departure procedure indicative of a route (and/or portion thereof) for departing from an aerial transportation facility, an arrival procedure indicative of a route (and/or portion thereof) for arriving at an aerial transportation facility, an approach procedure indicative of a route (and/or portion thereof) for approaching an aerial transportation facility, and/or an en-route procedure indicative of a route (and/or portion thereof) between two aerial transportation facilities.

The service entity computing system can obtain and/or generate a sequence of procedures to be followed for a route. For example, in some implementations, the procedure(s) can include one or more of a plurality of predefined (and/or preapproved) route sequences. In such a case, the service entity computing system can determine a route for an aerial vehicle and obtain one or more procedure identifiers for the route. The predefined procedures can be preloaded into one or more aerial vehicle devices (e.g., a vehicle computing system onboard an aerial vehicle, etc.) such that a route can be assigned to an aerial vehicle by providing the procedure identifier(s) for the route to the aerial vehicle device(s). In addition, or alternatively, the service entity computing can dynamically generate one or more procedure(s) and provide routing data indicative of the procedure(s) to the aerial vehicle device(s).

In some implementations, the routing data can include one or more contingency plans for one or more phases of a route. The contingency plan(s) can be indicative of a route plan for one or more potential contingencies at one or more times during a flight. The contingency plan(s) can include a plurality of contingency plans, the selection of which can be based on the nature and/or immediacy of a contingency. A contingency plan, for example, can include an action to continue to a nominal landing site, divert to a known and/or approved backup landing site, divert to a relatively safe landing site that may not have been preapproved for emergency landing, and/or land immediately in the safest possible location.

At times, the routing data can include one or more time thresholds. The one or more time thresholds can include a requested time of arrival for an aerial vehicle. For example, the requested time of arrival can be provided to an aerial vehicle to delegate responsibility for monitoring and/or implementing tactical speed adjustments to meet a desired arrival time. In addition, or alternatively, the routing data can include in-trail aircraft data indicative of an aircraft to track and follow along with a parameter specifying a following interval. Moreover, the routing data can include frequency information indicative of a frequency not typically used in routine operations. Frequency information, for example, can include a frequency at which an aerial traffic controller can verbally communicate with one or more operators of the aerial vehicle.

The service entity computing system can generate a routing request for the aerial vehicle based on the aerial vehicle device and the routing data. The routing request can include one or more routing commands, routing requirements, routing acknowledgements, routing targets, and/or any other data associated with a transportation service. By way of example, the routing request can be indicative of one or more route changes and/or trip assignments. For instance, the routing request can include a specification of a new route for the aerial vehicle. The new route can be indicative of a transportation service for completing an aerial portion of a multi-modal transportation service.

In some implementations, the service entity computing system can generate the routing request based on the vehicle model associated with the aerial vehicle and/or multi-modal transportation services data associated with a multi-modal transportation platform. For example, the routing request can be generated based on multi-modal transportation services data indicative of a plurality of requests for a multi-modal transportation service. By way of example, the routing request can be generated to facilitate an aerial transportation leg of a multi-modal transportation itinerary. As discussed herein, the routing request can be provided to an aerial vehicle device associated with the aerial vehicle to initiate the performance of the aerial transportation leg of the multi-modal transportation itinerary.

In addition, or alternatively, the routing request can be generated based on the vehicle model corresponding to the aerial vehicle. For instance, the service entity computing system can obtain a vehicle model corresponding to the aerial vehicle. The vehicle model can include vehicle data (e.g., aggregated from a plurality of different aerial vehicle devices) for the aerial vehicle in a device agnostic format. The service entity computing system can assign an aerial transportation leg of the multi-modal transportation itinerary to the aerial vehicle and, in response, generate the routing request for the aerial vehicle, based on the vehicle model. For example, the service entity computing system can determine that the aerial vehicle is available to provide the aerial transportation service (e.g., based on a flight state represented by the vehicle model), located proximate to a departure facility for the aerial transportation service (e.g., based on the current location represented by the vehicle model), has a power level required to perform the aerial transportation service (e.g., based on the energy level represented by the vehicle model), etc.

In some implementations, the routing request can include a request to change a current route of the aerial vehicle. For example, the service entity computing system can generate a routing request indicative of a modified route to augment an aerial vehicle's and/or aerial vehicle operator's situational awareness. The routing request, for example, can include a suggested route modification (and/or one or more route procedures) for an operator of the aerial vehicle. The operator can review and select the suggested route to approve the modification (and/or assignment).

The routing request can indicate a flight segment associated with one or more passengers (e.g., of the multi-modal transportation service). The routing request can include a command (e.g., for one or more service entity vehicles) and/or a request (e.g., for one or more third-party vehicles) to perform an aerial transportation leg of a multi-modal transportation service. In some implementations, the service entity computing system can log each of the routing requests. In this way, the service entity computing system can have full awareness of transmission and execution of uplinked routing requests.

The service entity computing system can determine an endpoint of the vehicle integration interface for providing the routing request to the aerial vehicle. For example, the service entity computing system can determine an aerial vehicle device (e.g., vehicle computing system, operator device, etc.) associated with the aerial vehicle. The service entity computing system can determine the endpoint based, at least in part, on the aerial vehicle device. By way of example, the endpoint can include one of a plurality of endpoints of the vehicle integration interface associated with the service entity. The endpoint can include the endpoint of the plurality of endpoints that corresponds to the aerial vehicle device (and/or the associated device provider/type).

The service entity computing system can provide, via the endpoint of the vehicle integration interface, the message (e.g., informational message, routing request, etc.) to the aerial vehicle device. In some implementations, the service entity computing system can translate the message (e.g., informational message, routing request, etc.) before providing the message (e.g., informational message, routing request, etc.) to the aerial vehicle device. For example, the message (e.g., informational message, routing request, etc.) can be formatted according to a device agnostic format. For instance, a routing request can include one or more instructions (e.g., command, request, etc.) formatted according to the device agnostic format. The service entity computing system can identify a device specific format corresponding to the aerial vehicle device (e.g., based on the device provider/type), obtain a data conversion function for the device specific format, and translate the message (e.g., instruction(s) and/or one or more other component(s) of a routing request, information message, etc.) to the device specific format (e.g., syntax, message format, data format, etc.) using the data conversion function. The service entity computing system can provide, via the endpoint of the vehicle integration interface, the resulting device specific message (e.g., device specific routing request, device specific informational message, etc.) such that the aerial vehicle device can accurately process the translated contents of the message.

In some implementations, the vehicle integration interface can include one or more transmission queue(s) for storing a plurality of messages (e.g., informational messages, routing requests, etc.) before the transmission of each of the messages (e.g., informational messages, routing requests, etc.) to a respective aerial vehicle device. The transmission queue(s), for example, can include one or more priority queues configured to transmit a message (e.g., informational message, routing request, etc.) based on a priority and/or a function of time associated with the message (e.g., informational message, routing request, etc.). For example, messages (e.g., informational messages, routing requests, etc.) can be provided to a plurality of different aerial vehicles in parallel, the respective aerial vehicle devices can be working with constrained bandwidths to receive communications, and/or the service entity computing system can provide multiple routing requests at once in a certain order. In such a case, the service entity computing system can assign a priority to each of the messages (e.g., informational messages, routing requests, etc.). The transmissions queue(s) can store the messages according to their priority and send a respective message based on the priority assigned to the message. In some implementations, a message (e.g., informational message, routing request, etc.) can include an expiration time limit. In the event that the expiration time limit is achieved before the message is provided to a respective aerial vehicle device, the message can be ignored and not sent to the aerial vehicle device. In some implementations, the service entity computing system can postpone translating a message until the message is ready (e.g., queued, etc.) for transmission and the expiration time limit has not been reached.

In some implementations, the service entity computing system can filter the messages (e.g., informational messages, routing requests, etc.) based on the appropriateness of the messages (e.g., informational messages, routing requests, etc.) for transmission to an aerial vehicle device. For example, the service entity computing system can determine whether the data flowing through the vehicle integration interface is permissible and appropriate (i.e., commands may not be capable of being sent to vehicles at all times) based on the vehicle model corresponding to the aerial vehicle. By way of example, the service entity computing system can assume the permissibility and/or appropriateness to provide messages (e.g., informational messages, routing requests, etc.) to one or more aerial vehicles. As another example, the service entity computing system can determine whether the messages (e.g., informational messages, routing requests, etc.) are appropriate based on the flight state and/or flight schedule of the aerial vehicle (e.g., as represented by the vehicle model). By way of the example, the messages (e.g., informational messages, routing requests, etc.) can be permissible in the event that the flight state and/or flight schedule is indicative of a preflight, after landing, or parked/charging state, etc. As another example, the service entity computing system can determine whether the messages (e.g., informational messages, routing requests, etc.) are appropriate based on the vehicle state (e.g., battery level, etc.) of the aerial vehicle (e.g., as represented by the vehicle model). For example, the messages (e.g., informational messages, routing requests, etc.) can be impermissible in the event that the aerial vehicle cannot complete a route/route modification based on low power level, etc. as represented by the vehicle model. As another example, the service entity computing system can predict whether the messages (e.g., informational messages, routing requests, etc.) are appropriate based on a history of vehicle states as represented by the vehicle model (e.g., previous phase logic (e.g., state data), current states (vehicle, flight, or other), history of current states, etc.).

In some implementations, the messages (e.g., informational messages, routing requests, etc.) can be associated with a retry policy. The retry policy can be indicative of time threshold and/or a retry action. By way of example, a message (e.g., informational message, routing request, etc.) can include an acknowledgement request. The acknowledgement request can include a request for an acknowledgement message to verify that the aerial vehicle device has received the message (e.g., informational message, routing request, etc.) and/or is initiating a command and/or request of a routing request. The service entity computing system can obtain an elapsed time indicative of a time period after the message (e.g., informational message, routing request, etc.) is provided and/or before an acknowledgement is received from the aerial vehicle device. In response to the elapsed time achieving the time threshold of the retry policy associated with the message (e.g., informational message, routing request, etc.), the service entity computing system can initiate the retry action. The retry action, for example, can include providing a second routing request to the aerial vehicle device, initiating one or more safety action(s) (e.g., notifying an operator, provider, etc. of the associated aerial vehicle/device, etc.), providing another routing request to another aerial vehicle device associated with the aerial vehicle, etc.

The retry policy can be determined for the routing request based on the message type (e.g., route request type, etc.), the aerial vehicle, and/or the aerial vehicle device. For example, the retry policy can be tailored to one or more aspects of a routing request. As an example, the retry policy can include a retry action based on the route request type. By way of example, the retry action can include not issuing another routing request for route requests indicative of a minor flight modification (e.g., suggested alternate route to avoid minor turbulence, etc.), issuing another routing request for route requests indicative of a flight assignment, issuing multiple additional route requests for route requests indicative of a contingency plan, etc. In addition, or alternatively, the frequency (e.g., time threshold) of the retry policy can be tailored to the route request type and/or aerial vehicle device. For example, the time threshold for the retry policy can be determined based on historical acknowledgement data associated with the aerial vehicle device. In this manner, the time threshold for the retry policy can be based on an expected acknowledgment time for the respective aerial vehicle device. As another example, time thresholds can be determined based on the route request type. By way of example, the time threshold can include a longer time threshold for route requests indicative of a minor flight modification (e.g., suggested alternate route to avoid minor turbulence, etc.) as compared to route requests indicative of a contingency plan, etc. As yet another example, the time threshold and/or retry action can be determined based on a message priority associated with the routing request. For instance, a retry action and/or time threshold can include one or more second routing requests for high priority routing requests, a shorter time threshold for high priority routing requests, no second routing request for low priority routing request, and/or a longer time threshold for low priority routing requests.

Example aspects of the present disclosure can provide a number of improvements to computing technology such as, for example, multi-modal transportation technology and ride sharing technology in general. For instance, the systems and methods of the present disclosure provide an improved approach for communicating across a number of disparate computing systems. The systems and methods of the present disclosure provide a centralized interface capable of interacting across a plurality of different platform technologies, communication protocols, data formats, etc. The interface includes a number of endpoints communicatively connected to a plurality of different devices with unique operating ecosystems. Communications received and/or provided via a respective endpoint can be translated between messaging formats unique to each of the different operating ecosystems. As a result, the systems and methods provided herein can aggregate data across a plurality of different devices. This, in turn, enables a ride-sharing platform to maintain up-to-date information for each of a number of different aerial vehicles that are maintained, operated, configured, and/or manufactured using distinct software architectures.

For example, a computing system can include a vehicle integration interface including a plurality of endpoints associated with one or more aerial vehicle devices. The computing system can obtain a communication associated with the aerial vehicle via an endpoint of the plurality of endpoints of the vehicle integration interface. The computing system can determine an aerial vehicle device corresponding to the communication based, at least in part, on the endpoint. The computing system can generate device agnostic telemetry data based, at least in part, on the device specific telemetry data and the aerial vehicle device. The computing system can update a vehicle model corresponding to the aerial vehicle based, at least in part, on the device agnostic telemetry data. And, the computing system can initiate one or more vehicle actions for the aerial vehicle based, at least in part, on the vehicle model. In this manner, the computing system described herein employs improved telecommunications techniques to interface with a plurality of computing systems configured to operate in distinct computing environments. This enables the computing system to accumulate and distribute newly available information such as, for example, a vehicle model containing telemetry information aggregated from the plurality of computing systems, etc. The computing system can utilize this data to make informed multi-modal transportation service decisions (e.g., routing decisions, rider assignment decisions, etc.) for a number of aerial vehicles designed and/or operated by different computing architectures. Ultimately, the computing system provides an improvement to the functioning of computing technology by enabling the seamless communication between a number of devices operated in accordance with a number of different communication protocols, data formats, message formats, etc.

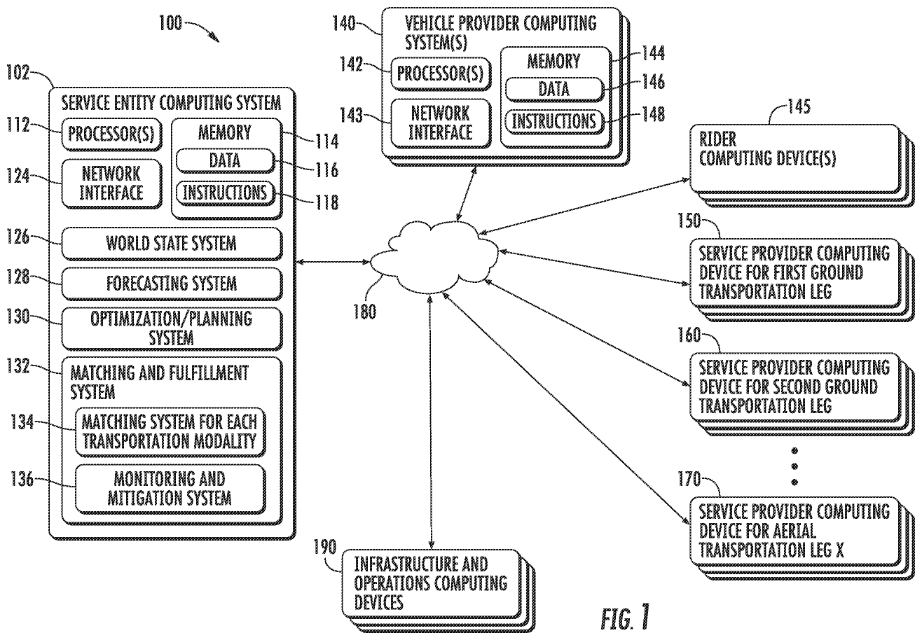

FIG. 1 depicts a block diagram of an example computing system 100 according to example embodiments of the present disclosure. The system 100 can include a service entity computing system 102 and a vehicle provider computing system 140 that can operate (e.g., collectively or individually) to control, route, monitor, and/or communicate with aircraft (e.g., VTOL aircraft) and/or one or more other transportation service entities to facilitate a multi-modal transportation service. These operations can be performed as part of a multi-modal transportation service for riders, for example, including travel by ground vehicle and travel by aircraft (e.g., VTOL aircraft).

The service entity computing system 102 can be communicatively connected over a network 180 to the vehicle provider computing system(s) 140, one or more rider computing devices 145, one or more service provider computing devices 150 for a first ground transportation leg, one or more service provider computing devices 160 for a second ground transportation leg, one or more service provider computing devices 170 for aerial transportation leg X, and/or one or more infrastructure and operations computing devices 190. For example, the vehicle provider computing system(s) 140 can include one or more network interfaces 143 communicatively connected to the service entity computing system 102 and the service entity computing system 102 can include one or more network interfaces 124 communicatively connected to the vehicle provider computing system(s) 140.

Each of the computing devices 145, 150, 160, 170, 190 can include any type of computing device such as a smartphone, tablet, hand-held computing device, wearable computing device, embedded computing device, navigational computing device, vehicle computing device, etc. A computing device can include one or more processors and a memory (e.g., similar to as will be discussed with reference to processors 112, 142 and memory 114, 144). Although service provider devices are shown for N different transportation legs, any number of different transportation legs can be used, including, for example, less than the three illustrated legs (e.g., two legs can be used).

The computing systems 102, 140 can include one or more processors 112, 142 and a memory 114, 144. The one or more processors 112, 142 can be any suitable processing device (e.g., a processor core, a microprocessor, an ASIC, a FPGA, a controller, a microcontroller, etc.) and can be one processor or a plurality of processors that are operatively connected. The memory 114, 144 can include one or more non-transitory computer-readable storage media, such as RAM, ROM, EEPROM, EPROM, one or more memory devices, flash memory devices, etc., and combinations thereof.

The memory 114, 144 can store information that can be accessed by the one or more processors 112, 142. For instance, the memory 114, 144 (e.g., one or more non-transitory computer-readable storage mediums, memory devices) can store data 116, 146 that can be obtained, received, accessed, written, manipulated, created, and/or stored. In some implementations, the computing system(s) 102, 140 can obtain data from one or more memory device(s) that are remote from the system(s) 102, 140.

The memory 114, 144 can also store computer-readable instructions 118, 148 that can be executed by the one or more processors 112, 142. The instructions 118, 148 can be software written in any suitable programming language or can be implemented in hardware. Additionally, or alternatively, the instructions 118, 148 can be executed in logically and/or virtually separate threads on processor(s) 112, 142. For example, the memory 114, 144 can store instructions 118, 148 that when executed by the one or more processors 112, 142 cause the one or more processors 112, 142 to perform any of the operations and/or functions described herein.

The service entity computing system 102 can receive a request (e.g., via network(s) 180) from a rider (e.g., via the rider computing device(s) 145) that requests for the service entity computing system 102 to facilitate a transportation service for the rider from an origin location to a destination location. For example, the rider can interact with a dedicated application on the rider computing device 145 (e.g., smartphone, tablet, wearable computing device, or the like) to initiate the request. By way of example, the rider can interact with the rider computing device 145 by opening the dedicated application and/or initiating a booking process via the dedicated application. The service entity computing system 102 can initiate the generation of a plurality of multi-modal transportation itineraries in response to the rider opening the dedicated application and/or otherwise initiating a booking process.

In response to the request, the service entity computing system 102 can generate at least one itinerary that includes transportation of the rider from the origin location to the destination location. Specifically, the service entity computing system 102 can generate an end-to-end multi-modal transportation itinerary including a plurality of transportation legs that include transportation via a plurality of different transportation modalities. The end-to-end multi-modal transportation itinerary can include two or more transportation legs that include travel via two or more different transportation modalities such as, for example: cars, motorcycles, light electric vehicles (e.g., electric bicycles or scooters), buses, trains, aircraft (e.g., airplanes), watercraft, walking, and/or other transportation modalities. Example aircrafts can also include helicopters and other vertical take-off and landing aircraft (VTOL) such as electric vertical take-off and landing aircraft (eVTOL). The vehicles can include non-autonomous, semi-autonomous, and/or fully-autonomous vehicles.

In some implementations, the service entity computing system 102 can facilitate the ability of the rider to receive transportation on one or more of the transportation legs included in the multi-modal transportation itinerary. As one example, the service entity computing system 102 can interact with one or more service provider computing device(s) 150, 160, 170 to match the rider with one or more transportation service providers. As another example, the service entity computing system 102 can book or otherwise reserve a seat in, space on, or usage of one or more of the transportation modalities for the rider. Additionally, or alternatively, the service entity computing system 102 can collaborate with the vehicle provider computing system 140 to provide information for options to be provided by the vehicle provider computing system 140 for one or more of the transportation legs.

More particularly, in some implementations, the service entity computing system 102 can respond to the rider's request by determining whether it is better to fulfill the rider's request using a single transportation modality or using multiple transportation modalities. As one example, the service entity computing system 102 can evaluate the rider's current location, origin location, and/or destination location to determine which modalities of transportation are usable at such location (e.g., able to access such locations). For example, the location(s) can be checked against a list of permitted locations that have been approved for participation in various types of modalities (e.g., flight modalities for the purpose of generating a multi-modal trip itinerary). As another example, the service entity computing system 102 can evaluate (e.g., generate) one or more itineraries that are single-modal and one or more itineraries that are multi-modal (e.g., inclusive of various combinations of different transportation modalities). The service entity computing system 102 can compare the generated single- and multi-modal itineraries to determine whether it is appropriate to suggest a single- or multi-modal itinerary to the rider. For example, one or more of the best itineraries (e.g., as evaluated based on various characteristics such as cost, time, etc.) can be suggested to the rider. The rider can select, via the rider computing device 145, one of the suggested itineraries to receive transportation services in accordance with the selected itinerary.

In some implementations, the service entity computing system 102 can continually reevaluate various itineraries (e.g., single- and/or multi-modal itineraries) before and even during completion of a selected itinerary. If an improved itinerary becomes available (e.g., which may include changing from a single-modal itinerary to a multi-modal itinerary if, for example, a seat on a flight becomes available) the service entity computing system 102 can suggest the improved itinerary for selection by the rider. In some implementations, if the rider selects, via the rider computing device(s) 145, the improved itinerary during completion of an existing itinerary, the service entity computing system 102 can facilitate switching to the updated itinerary, including, for example, rerouting a service provider that is currently transporting the rider to an alternative, updated destination.

Thus, in response to the rider's request, the service entity computing system 102 can perform one or more algorithms to generate a multi-modal transportation itinerary for the rider. As an example, in some implementations, the service entity computing system 102 can sequentially analyze and identify potential transportation legs for each different available transportation modality. For example, a most critical, challenging, and/or supply-constrained transportation leg can be identified first and then the remainder of the itinerary can be stitched around such leg. In some implementations, the order of analysis for the different modalities can be a function of a total distance associated with the transportation service (e.g., shorter transportation services result in ground-based modalities being assessed first while longer transportation services result in flight-based modalities being assessed first).

As one particular example, in some implementations, the service entity computing system 102 can initially analyze a first transportation modality that is the most efficient (e.g., in terms of travel speed and/or cost) transportation modality which operates according to a fixed infrastructure. As an example, for most longer transportation services and for the mix of different modalities described above, flight modalities can both be the most efficient transportation modality (e.g., in terms travel speed/time) while also operating according to a fixed infrastructure. By first analyzing the most efficient transportation modality which operates according to a fixed infrastructure, the service entity computing system 102 can seek to identify an important transportation leg around which the remainder of the itinerary can be stitched.

More particularly, in some implementations, one or more of the transportation modalities can operate according to or within a fixed transportation infrastructure in which the ability of passengers to embark and disembark vehicles is constrained to a defined set of transportation nodes. As one example, in some implementations, aerial vehicles that operate within the ride sharing network can be constrained to load and unload passengers only at a defined set of physical take-off and/or landing areas which may in some instances be referred to as aerial transportation facilities. To provide an example, a large urban area may have dozens of transportation nodes located at various locations within the urban area. Each transportation node can include one or more landing pads and/or other infrastructure to enable passengers to safely embark or disembark from aerial vehicles. The take-off and/or landing areas of the transportation nodes can be located at ground level and/or elevated from ground-level (e.g., atop a building).

Transportation nodes can include charging equipment, refueling equipment, and/or other infrastructure for enabling aerial operation. The infrastructure and operations computing devices 190 can be any form of computing device used by and/or at the infrastructure or operations personnel including, for example, devices configured to perform passenger security checks, luggage check in/out, recharging/refueling, vehicle climate control, safety briefings, vehicle check in/out, and/or the like.

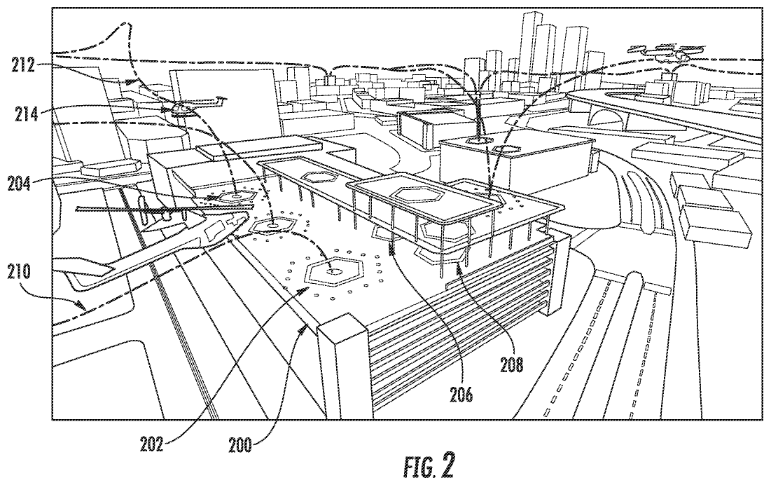

As an example, FIG. 2 depicts a graphical diagram of an example transportation node according to example embodiments of the present disclosure. The example transportation node 200 can include a number of take-off/landing pads such as pads 202 and 204. In addition, the example transportation node 200 can include a number of vehicle parking locations such as parking locations 206 and 208. For example, refueling or recharging infrastructure may be accessible at each parking location. Flight trajectories into and out of the transportation node 200 can be defined, configured, assigned, communicated, etc. FIG. 2 illustrates a number of flight trajectories including, for example, trajectories 210 and 212. The trajectories can be fixed or can be dynamically computed. The trajectories can be computed by the aircraft or can be centrally computed and then assigned and communicated to the aircraft. As one example, FIG. 2 illustrates a helicopter 214 taking off from the pad 204 according to the trajectory 212.

Turning back to FIG. 1, the service entity computing system 102 can initially analyze the transportation modality that is the most supply-constrained. More particularly, certain transportation modalities may be more supply-constrained than other modalities in terms of number of available service providers and/or average number of services provided daily. For example, at least in the near future and due to the relatively larger challenge and cost involved with operating aerial vehicles, flight modalities are likely to be more supply-constrained than ground-based modalities such as cars. Because the most supply-constrained modality represents the most option-limiting aspect of building different itineraries, by first analyzing the most supply-constrained modality the service entity computing system 102 can more efficiently generate the multi-modal transportation itinerary.

The service entity computing system 102 can initially identify any fixed transportation nodes (e.g., aerial transportation facilities) associated with a transportation modality (e.g., aerial transportation modality) that are relevant to the rider's request. For example, the service entity computing system 102 can identify any nodes that are within a threshold distance from the origin location as candidate departure nodes. Likewise, the service entity computing system 102 can identify any nodes that are within a threshold distance from the destination location as candidate arrival nodes.

The service entity computing system 102 can include and/or be associated with a number of subsystems (e.g., world state system 126, forecasting system 128, optimization/planning system 130, matching and fulfillment system 132, etc.) configured to provide a plurality of backend services to facilitate a transportation service. By way of example, the optimization/planning system 130 can provide a backend itinerary service to generate one or more multi-modal transportation itineraries for a rider in accordance with the procedures described herein. The systems 126-132 can cooperatively interoperate (e.g., including supplying information to each other).

More particularly, the world state system 126 can operate a state monitoring service to maintain data descriptive of a current state of the world. For example, the world state system 126 can generate, collect, and/or maintain data descriptive of planned itineraries; predetermined transportation plans (e.g., flight plans) and assignments; current requests; current ground transportation service providers; current aerial transport facility operational statuses (e.g., including recharging or refueling capabilities); current aerial vehicle statuses (e.g., including current fuel or battery level); current pilot statuses; current flight states and trajectories; current airspace information; current weather conditions; current communication system behavior/protocols; and/or the like. For instance, the world state system 126 can be configured to obtain world state data through communication (e.g., via an API platform) with one or more vehicles (e.g., via service provider device(s) 150, 160, 170), vehicle providers (e.g., vehicle provider computing system(s) 140), and/or any other transportation entity associated with the service entity computing system 102.

As another example, the forecasting system 128 can operate a forecasting service to generate predictions of transportation demand, weather forecasts, and/or any other future looking data helpful for completing a transportation service. The forecasting system 128 can generate predictions of the demand and supply for transportation services at or between various locations over time. The forecasting system 128 can also generate or supply weather forecasts. The forecasts made by the system 128 can be generated based on historical data and/or through modeling of demand and supply.

The optimization/planning system 130 can generate transportation plans for various transportation assets and/or can generate itineraries for riders. For example, the optimization/planning system 130 can perform and/or facilitate flight planning. As another example, the optimization/planning system 130 can plan or manage/optimize itineraries which include interactions between riders and service providers or vehicle providers across multiple modes of transportation. The matching and fulfillment system 132 can match a rider with a service provider for each of the different transportation legs. For example, each respective matching system 134 can communicate with the corresponding service provider computing devices 150, 160, 170 via one or more APIs or connections. Each matching system 134 can communicate trajectories and/or assignments to the corresponding service providers or vehicle providers. Thus, the matching and fulfillment system 132 can perform or handle assignment of ground transportation, flight trajectories, take-off/landing, etc.

The monitoring and mitigation system 136 can perform monitoring of rider itineraries and can perform mitigation when an itinerary is subject to significant delay (e.g., one of the legs fails to succeed). Thus, the monitoring and mitigation system 136 can perform situation awareness, advisories, adjustments and the like. The monitoring and mitigation system 136 can trigger alerts and actions sent to the systems 140 or devices 145, 150, 160, 170, and 190. For example, entities such as riders, service providers, and/or operations personnel can be alerted when a certain transportation plan has been modified and can be provided with an updated plan/course of action. Thus, the monitoring and mitigation system 136 can have additional control over the movement of aerial vehicles, ground vehicles, air traffic controllers, pilots, and riders.

In some instances, the service entity computing system 102 (e.g., optimization/planning system 130, etc.) may have at least some control and/or input over transportation services provided by service providers on at least some of the transportation modalities and, therefore, may predetermine, plan, and/or facilitate a number of planned transportation services by the service providers. For example, in some implementations, the service entity computing system 102 can communicate with one or more device(s) associated with one or more aerial vehicle(s) (e.g., vehicle provider device(s) 140, service provider computing device(s) 150, 160, 170, etc.) to receive information (e.g., telemetry information) from the aerial vehicle(s). As described in further detail herein, the service entity computing system 102 can generate and/or obtain routing information and provide the routing information to the aerial vehicle(s) to facilitate one or more flight plans for providing a multi-modal transportation service.

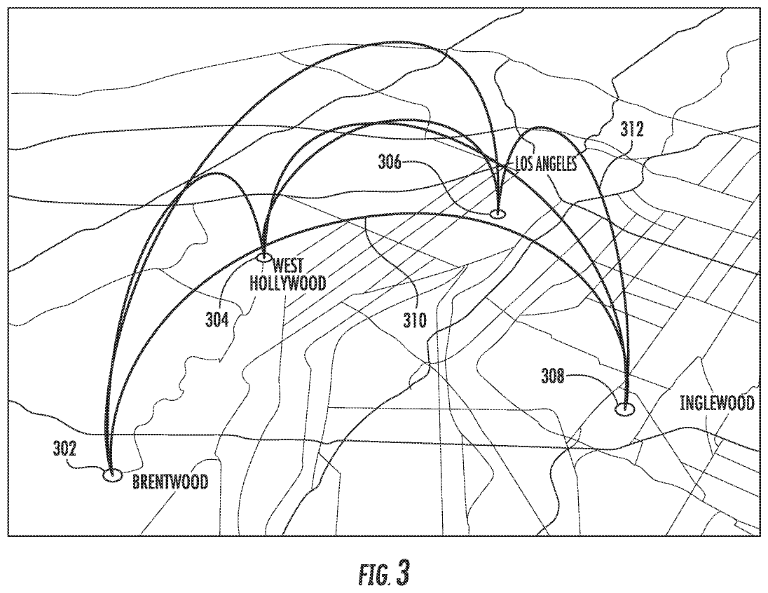

As an example, FIG. 3 depicts a graphical diagram of an example set of flight plans between an example set of transportation nodes according to example embodiments of the present disclosure. In particular, FIG. 3 provides a simplified illustration of an example fixed infrastructure associated with flight-based transportation in an example metropolitan area. As illustrated in FIG. 3, there can be four transportation nodes which may be referred to as “aerial transportation facilities.” For example, a first transportation node 302 is located in a first neighborhood of the metropolitan area, a second transportation node 304 is located in a second neighborhood, a third transportation node 306 is located in a third neighborhood, and a fourth transportation node 308 is located in a fourth neighborhood. The location and number of transportation nodes is provided only as an example. Any number of transportation nodes at any different locations can be used. Flights can be available (e.g., may be preplanned, dynamically planned, etc.) between certain pairs of the transportation nodes. For example, a flight path 310 can exist between the first transportation node 302 and the fourth transportation node 308. Likewise, a flight path 312 can exist between the fourth transportation node 308 and the third transportation node 306.

Turning back to FIG. 1, the service entity computing system 102 can provide access to one or more services of the service entity and/or otherwise interact with systems (e.g., third-party vehicle computing systems, third-party air traffic control systems, etc.) and/or aerial vehicle devices associated with service entity. For example, the service entity computing system 102 (and/or one or services thereof) can communicate with the aerial vehicle(s) (e.g., service entity vehicles, third-party vehicles, etc.) to obtain information from the vehicles and/or provide one or more message(s) such as, for example, requests for vehicle actions in accordance with a multi-modal transportation network.

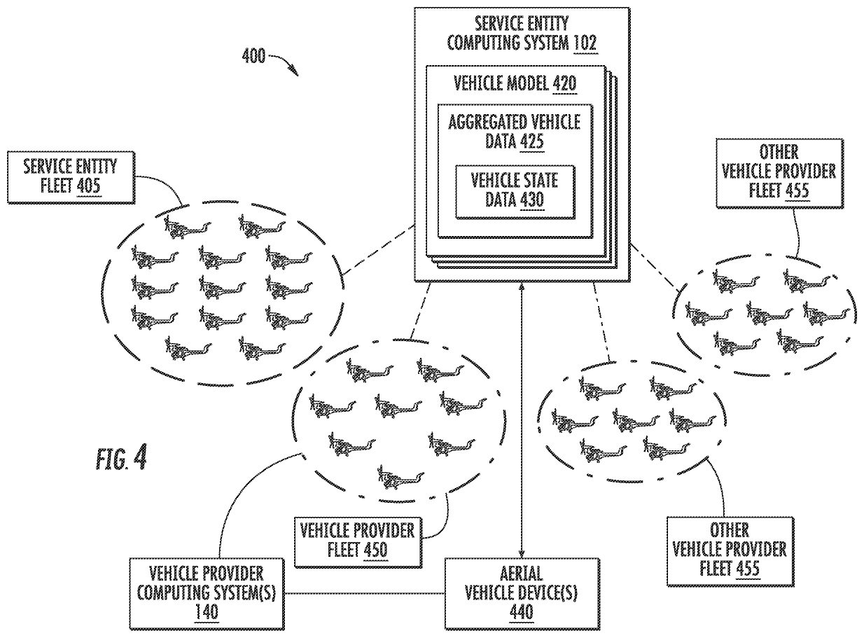

For example, FIG. 4 depicts an example vehicle provider ecosystem 400 according to example embodiments of the present disclosure. The service entity computing system 102 can utilize service entity vehicle(s) of the service entity fleet 405 and/or one or more third-party vehicle(s) from one or more third-party aerial vehicle provider fleet(s) 450, 455 to perform one or more aerial transportation services (e.g., throughout an operational time period such as an hour, day, week, etc.). The number of aerial vehicles available from the one or more third-party aerial vehicle provider(s) (e.g., vehicle provider associated with vehicle provider computing system 140) can be independently available to a plurality of different ride-sharing platforms.

For example, a vehicle provider (e.g., associated with vehicle provider computing system 140) and/or the other aerial vehicle providers can be associated with a vehicle provider fleet 450 and/or a respective other vehicle provider fleet 455. Each fleet 450, 455 can include one or more aerial vehicles associated (e.g., managed, operated, scheduled, etc.) with a respective vehicle provider. The aerial vehicle(s) can include one or more autonomous, semi-autonomous, and/or non-autonomous aerial vehicles. The vehicle(s) can include any type of aircraft such as, for example, helicopters and/or other vertical take-off and landing aircraft (VTOL) including electric vertical take-off and landing aircraft (eVTOL). For instance, the vehicles can include one or more electric vehicles such as, for example, electric vertical and take-off and landing vehicles. The electric vehicles can be powered by one or more electric batteries.

The vehicle provider computing system 140 can be configured to manage, maintain, and/or schedule the fleet of aerial vehicles 450 across a plurality of aerial transportation facilities based on information associated with the vehicles and/or vehicle provider. In addition, or alternatively, the service entity computing system 102 can be configured to manage, maintain, and/or schedule the fleet of aerial vehicles 450. For example, in some implementations, the service entity computing system 102 can perform one or more of the functions of the vehicle provider computing system 140 as described herein.

Each aerial vehicle (e.g., service entity vehicle, third-party vehicle 445, etc.) can be associated with one or more aerial vehicle device(s) 440. The aerial vehicle device(s) 440 can include a plurality of different devices associated with the operations of a respective aerial vehicle 445. For instance, the device(s) 440 can include a device associated with the service entity computing system 102 (e.g., for service entity vehicles), a device associated with the vehicle provider computing system 140 (e.g., for third-party vehicles), an operator device (e.g., mobile phone, etc.) associated with an operator of the aerial vehicle 445, a navigational device (e.g., avionic navigation devices manufactured by various manufacturers) onboard the aerial vehicle 445, a device associated with a vehicle computing system (e.g., an onboard computing system of the aerial vehicle, a commercial drone device, a hobby drone device, etc.) onboard the aerial vehicle 445, a user device that can communicate with the avionics of the aerial vehicle (e.g., a tablet of the pilot, etc.), and/or any other device associated with the respective aerial vehicle 445. The service entity computing system 102 (and/or one or services thereof) can communicate with the aerial vehicle device(s) 440 to interact (e.g., assign a flight, obtain a current location, etc.) with a respective aerial vehicle 445.

The service entity computing system 102 can interact with the aerial vehicle device(s) 440 to facilitate one or more aerial transportation services of a multi-modal transportation itinerary. For example, the service entity computing system 102 can obtain and/or facilitate the scheduling of one or more candidate flight itineraries for the aerial vehicles 405, 450. In response to a request for a multi-modal transportation service, the service entity computing system 102 can identify candidate transportation plans between one or more transportation facilities relevant (e.g., proximate to an origin or destination location of the transportation request) to the request. In some implementations, for example, the vehicle provider computing system 140 can provide a flight schedule (e.g., for each aerial vehicle, for each of the relevant nodes, etc.) to the service entity computing system 102. Additionally, or alternatively, the service entity computing system 102 can generate a flight schedule (e.g., for each vehicle, for each of the relevant nodes, etc.). The service entity computing system 102 can be configured to generate one or more multi-modal transportation itineraries based, at least in part, on the flight schedules and multi-modal transportation data. For example, the service entity computing system 102 can identify any transportation plans between one of the candidate departure nodes and one of the candidate arrival nodes which would satisfy a request for a multi-modal transportation itinerary, including, for example, any departure or arrival time requests. The service entity computing system 102 can stitch one or more additional legs to a respective transportation plan to generate a multi-modal transportation itinerary.

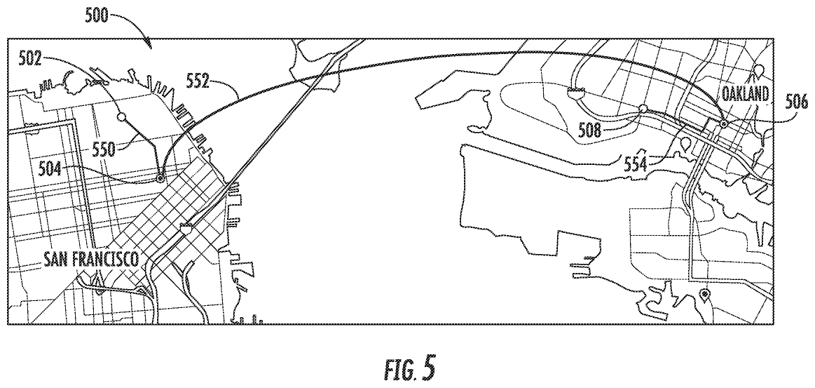

By way of example, FIG. 5 depicts a graphical diagram of an example multi-modal transportation service itinerary 500 according to example embodiments of the present disclosure. The multi-modal transportation itinerary 500 can include three transportation legs to transport the rider from an origin 502 to a destination 508. In particular, the multi-modal transportation itinerary 500 can include a first, ground-based (e.g., car-based) transportation leg 550 which transports the rider from the origin 502 to a departure transportation node 504; a second, flight-based transportation leg 552 which transports the rider from the departure transportation node 504 to an arrival transportation node 506; and a third, ground-based (e.g., car-based) transportation leg 554 which transports the rider from the arrival transportation node 506 to the destination 508. More particularly, the multi-modal transportation itinerary 500 can include a first ground transportation leg 550 from the origin location 502 to a first aerial transportation facility 504, an aerial transportation leg 552 from the first aerial transportation facility 504 to a second aerial transportation facility 506, and a second ground transportation leg 554 from the second aerial transportation facility 506 to the destination location 508. The aerial transportation leg 552 can include a selected plan (e.g., flight itinerary) of one or more candidate flight itineraries obtained from the vehicle provider computing system.

Turning back to FIG. 1, the service entity computing system 102 (e.g., optimization/planning system 130) can receive multi-modal transportation data indicative of one or more requests for a plurality of transportation services and generate the plurality of multi-modal transportation itineraries for facilitating the plurality of transportation services. An aerial vehicle can be assigned (e.g., by the service entity computing system 102, the vehicle provider computing system 140, etc.) to provide at least one leg of the multi-modal transportation itinerary. The service entity computing system 102 (e.g., matching and fulfillment system 132) and/or the vehicle provider computing system 140 can schedule, track the progress of, and/or modify each of the plurality of multi-modal transportation itineraries and/or one or more transportations legs thereof during an operational time period.

More particularly, the service entity computing system (e.g., an optimization/planning system 130) can receive multi-modal transportation services data indicative of one or more requests for a plurality of transportation services and generate the plurality of multi-modal transportation itineraries for facilitating the plurality of transportation services based on the one or more requests and the flight schedule(s) provided by the vehicle provider(s) and/or scheduled based on the data received from a plurality of aerial vehicles (e.g., aerial vehicles 405, 450, etc.). For example, the multi-modal transportation service data can be indicative of a plurality of multi-modal transportation services. The plurality of multi-modal transportation services can be associated with one or more aerial transportation services. As an example, each multi-modal transportation service can include at least two transportation legs. At least one of the at least two transportation legs can be facilitated by at least one of the one or more aerial transportation services (e.g., via a flight itinerary of the one or more flight schedules or scheduled based on the vehicle data).

The service entity computing system (e.g., an optimization/planning system 130) can facilitate each multi-modal transportation service (and/or aerial transportation service thereof) by interacting (e.g., via network(s) 180) with one or more aerial vehicle devices (e.g., aerial vehicle device(s) 440) associated with the plurality of aerial vehicles. The network(s) 180 can be any type of network or combination of networks that allows for communication between devices. In some embodiments, the network(s) can include one or more of a satellite network, local area network, wide area network, the Internet, secure network, cellular network, mesh network, peer-to-peer communication link and/or some combination thereof and can include any number of wired or wireless links. Communication over the network(s) 180 can be accomplished, for instance, via a network interface using any type of protocol, protection scheme, encoding, format, packaging, etc. As described in further detail herein, in some implementations, the aerial vehicle device(s) can be associated with a number of different protocols, protection schemes, encodings, formats, packagings, etc. The service entity computing system 102 can include a vehicle integration interface configured to facilitate communications between each of the aerial vehicle devices via a number of different protocols, protection schemes, encodings, formats, packagings, etc.

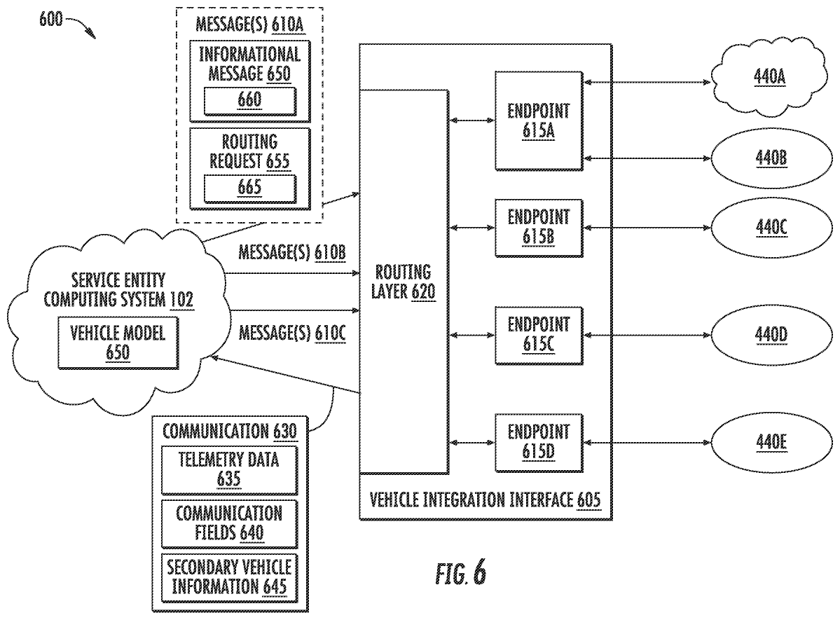

FIG. 6 depicts an example vehicle integration interface system 600 according to example embodiments of the present disclosure. The system 600 can include a vehicle integration interface 605 configured to proxy messages 610A-C and/or communications 630 between the service entity computing system 102 and one or more aerial vehicle device(s) 440A-E. The vehicle integration interface 605 can include a routing layer 620 and/or one or more endpoint(s) 615A-D. The routing layer 620 can include a downlink component and/or an uplink component. The downlink component can include a downstream receiver of all message(s) 610A-C from aerial vehicle device(s) 440A-E. The downlink component can be configured to receive the message(s) 610A-C, triage and prioritize the message(s) 610A-C, and route the message(s) 610A-C to a respective backend system of the service entity computing system 102. The uplink component can include a downstream receiver of all communication(s) 630 from the service entity computing system 102 (and/or backend systems thereof). The uplink component can be configured to receive the communication(s) 630, triage and prioritize the communication(s) 630, and route the communication(s) 630 to a respective endpoint of the vehicle integration interface 605. In some implementations, the routing layer 620 can be configured to forward message(s) 610A-C and/or communication(s) 630 within an appropriate time window for translation and transmission.

The service entity computing system 102 can be configured to communicate with device(s) 440A-E of various device providers (e.g., vehicle device providers, navigational device providers, user device providers, etc.) via the vehicle integration interface 605 to facilitate a multi-modal ride-sharing network. The device providers can include any entity associated with the operation of an aerial vehicle. For instance, the device providers can be associated with the one or more aerial vehicle device(s) 440A-E (e.g., aerial vehicle provider device(s), operator device(s), onboard vehicle device(s), navigation device(s), etc.) associated with service entity and/or third party aerial vehicle(s) of FIG. 4. The respective device provider, for example, can include one or more manufacturers (e.g., vehicle manufacturers, device manufacturers, onboard systems manufacturers, etc.) and/or providers of the subset of aerial vehicle device(s). By way of example, the subset of aerial vehicle device(s) can include one or more navigational device(s) manufactured by the respective device provider. As another example, the subset of aerial vehicle device(s) can include one or more vehicle computing devices installed, manufactured, and/or maintained by the respective device provider (e.g., service entity, third-party entity, etc.). For example, the respective device provider can include a third-party vehicle provider and/or a service entity vehicle provider associated with the aerial vehicle device(s). As yet another example, the subset of aerial vehicle device(s) can include device(s) associated with a respective device type of the one or more type(s) (e.g., commercial drones, hobby drones, etc.). Each device type can be associated with one or more communication protocols, data formats, message formats, etc. for device(s) of the respective device type.

The vehicle integration interface 605 can include and/or have access to an application programming interface (API) platform that can facilitate communication between the service entity infrastructure (e.g., the services of the service entity computing system 102, etc.) and the aerial vehicle device(s) 440A-E (e.g., device(s) associated with aerial vehicle(s), etc.). The API platform can include one or more functional calls to the backend services of the service entity computing system 102. By way of example, the one or more functional calls can be configured to communicate a request and/or data between one or more subsystems (e.g., world state system, forecasting system, optimization/planning system, etc.) of the service entity computing system 102 and the aerial vehicle device(s) 440A-E. In this way, backend services of the service entity computing system 102 can interact, via the vehicle integration interface 605, with aerial vehicle device(s) 440A-E associated with a plurality of aerial vehicles configured to provide one or more aerial transportation services for a multi-modal ride sharing platform.

More particularly, the vehicle integration interface 605 can be configured to connect with a plurality of endpoints 615A-615D associated with the aerial vehicle device(s) 440A-E. Each aerial vehicle device 440A-E can be associated with a corresponding endpoint of the plurality of endpoints 615A-D. As an example, endpoint 615A can be associated with aerial vehicle device(s) 440A, 440B, endpoint 615B can be associated with aerial vehicle device 440C, endpoint 615C can be associated aerial vehicle device 440D, endpoint 615D can be associated aerial vehicle device 440E.

Each aerial vehicle device 440A-E can be matched to a respective endpoint during an onboarding process for a corresponding type of aerial vehicle device. For example, the endpoints 615A-D can include a device-specific endpoint configured to communicate messages/communications with device(s) of a respective device type. During the onboarding process, aerial vehicle devices of a respective device type can be instructed to communicate with a corresponding endpoint. For instance, the respective aerial vehicle devices can be configured to communicate with the corresponding endpoint via a respective communication frequency, communication protocol, etc. associated with the corresponding endpoint. The corresponding endpoint can be configured to receive messages provided to the service entity computing system 102 via the respective communication frequency, communication protocol, application programming interface, etc. associated with the corresponding endpoint. In addition, the corresponding endpoint can utilize the respective communication frequency, communication protocol, application programming interface, etc. to provide messages to one or more of the device(s) of the respective device type.

An endpoint 615B, for example, can include a uniform resource locator corresponding to at least one aerial vehicle device 440C. The corresponding endpoint 615B for a respective aerial vehicle device 440C can identify a connection (e.g., network connection, gateway device, a series of protocols, a frequency, etc.) with the respective aerial vehicle device 440C. For example, the service entity computing system 102 can provide information (e.g., communication(s) 630 (e.g., information message(s) 650, routing request(s) 655, etc.), etc.) to the respective aerial vehicle device 440C via the corresponding endpoint 615B of the vehicle integration interface 605. In addition, or alternately, the respective aerial vehicle device 440C can provide information (e.g., communication(s) 630 (e.g., a telemetry data 635, communication fields 640, secondary vehicle information 645, etc.), etc.) to the service entity computing system 102 via the corresponding endpoint 615B of the vehicle integration interface 605.

In some implementations, each endpoint 615A-D of the vehicle integration interface 605 can facilitate communication between the service entity computing system 102 and a subset of the aerial vehicle device(s) that are associated with a respective device provider and/or device type. For example, each endpoint 615A-D can include vendor type specific communicator that is unique to a certain provider/device combination. The type specific communicator can be responsible for taking information from the service entity computing system 102 and translating the information to a command syntax and/or schema that a specific vehicle/device is capable of parsing (e.g., directly from the service entity computing system, indirectly via an external provider service, etc.). The translated information can be queued for consumption by the appropriate type and can expire if not consumed in time. The consumption of the information by the specific device of the device type can be initiated by the device and/or device provider thereof (e.g., polled) or by the service entity computing system (e.g., pushed). Each endpoint 615A-D can be tailored to suit the network topology of the integrating device provider.

More particularly, device provider(s) and/or device type(s) (and/or the associated aerial vehicle device(s) 440A-E) can be associated with one or more different aerial device format(s). For example, each of the aerial vehicle device(s) 440A-E can be associated with a respective aerial device format of a plurality of aerial device formats. An aerial device format, for example, can include at least one of a plurality of different aerial device standards for transferring and/or manipulating data by an aerial vehicle device (e.g., device(s) 440A-E). For instance, each aerial device format can include a syntax, communication protocols, interface timing, data formats, messaging formats, etc. with which different aerial vehicle devices 440A-E can communicate data. An aerial device format can define, for example, a specific message format, data representation formats, etc. for data transferring and/or processing by a respective aerial vehicle device. In some implementations, each aerial device format can be indicative of (and/or defined by) one or more computer programming languages (e.g., computer-readable instructions) and/or software that when compiled (e.g., by a respective compiler) can cause one or more processors of a respective aerial vehicle device to perform operations.

The service entity computing system 102 can receive information associated with each of a plurality of associated vehicles from the aerial vehicle device(s) 440A-E via the vehicle integration interface 605. For example, the service entity computing system 102 can obtain a communication 630 associated with an aerial vehicle via an endpoint 615B (e.g., routed by the routing layer 620) of the plurality of endpoints 615A-D of the vehicle integration interface 605. The communication 630 can include device specific telemetry data, communication fields, and/or secondary vehicle information. For example, the device specific information (e.g., telemetry data, communication fields, secondary vehicle information, etc.) can include the information (e.g., telemetry data 635, communication fields 640, secondary vehicle information 645, etc.) formatted according to an aerial device format corresponding to the aerial vehicle device 440C that provided the communication 630.

For example, the device specific telemetry data can be indicative of telemetry data 635 for the aerial vehicle. The telemetry data 635 can be indicative of current vehicle information for an aerial vehicle. The telemetry data 635 can include data indicative of an updated location, energy, route, health, and/or configuration of the aerial vehicle. For instance, the telemetry data 635 can include location data (e.g., indicative of a current vehicle location), fleet management information (e.g., indicative of management assignments, tasks, etc. associated with the aerial vehicle), routing information (e.g., indicative of an update to a route with which the vehicle is currently and/or scheduled to travel), flight information (e.g., indicative of a current vertical/lateral aircraft state, etc.), energy information (e.g., indicative of current fuel/battery consumption, an update to the fuel/battery level, etc.), vehicle systems health reporting (e.g., indicative a of vehicle health state, etc.). The vehicle systems health reporting, for example, can be indicative of any abnormalities that can be associated with a potentially actionable event such as, for example, an engine temperature, speed, communication system interference, etc. In some implementations, the telemetry data 635 can identify a current flight state representing the current stage (e.g., ground, takeoff, inflight, landing, etc.) of a flight. In addition, or alternatively, the telemetry data 635 can include vehicle configuration data representing the mechanical configuration of one or more vehicle components such as, for example, a flaps position, landing gear position, engine throttle position, etc. This can include, for example, component sensor data configured to measure the position of the vehicle component(s).

The telemetry data 635 can include data possessed by the avionics of an aerial vehicle. For instance, such data can include the current latitude, longitude, and/or navigation accuracy estimates and/or categories; altitude (e.g., a GNSS WGS84 and/or accuracy estimate, uncorrected and/or corrected pressure altitude, or an AGL altitude if measured directly along with an accuracy estimate); airspeed (e.g., indicated airspeed, equivalent airspeed, true airspeed, calibrated airspeed, etc.); groundspeed; heading and course (e.g., direction of aircraft nose and/or ground track velocity vector in degrees true, degrees magnetic, etc.); attitude; body-axis attitude rates; reference values of state parameters the flight control system is tracking (e.g., altitude, airspeed, heading, etc.); and/or an integrity, accuracy, and/or uncertainties of one or more position (e.g., latitude, longitude, etc.) measurements (e.g., navigation integrity category, natural areas code, source integrity level, etc. for global positioning system technology).

In addition, the telemetry data 635 can include trajectory intent for the aerial vehicle. The trajectory intent, for example, can include data indicative of the intended path of flight for the aerial vehicle. The data can include a set of sequential four dimensional (e.g., latitude, longitude, altitude, time, etc.) trajectory points. In some implementations, the trajectory points can include planned/predicted state data at each point (e.g., velocities, attitudes, attitude rates, etc.). By way of example, the trajectory points can be calculated by defining a position/altitude of the aerial vehicle as an analytical function of time. In addition, or alternatively, the data indicative of the intended path of flight for the aerial vehicle can include a set of tactical instructions. The set of tactical instructions can include a dead-reckoning trajectory with a time and/or point in space (e.g., trajectory-change points) in which a new set of dead-reckoning constraints can apply (e.g., climb-to-and-maintain 3000 ft). In some implementations, the data can include the provisioning of a procedure (e.g., following an airspace “letter of agreement”) without a time-based prediction. In addition, or alternatively, the data can include a dead reckoning trajectory indicating that the aerial vehicle will continue to follow a given heading/course and vertical rate indefinitely.

In some implementations, the telemetry data 635 can include airspace data. The airspace data can include information about the state of the airspace proximate to the aerial vehicle such as information from an ADS-B (e.g., ownership and other aircraft telemetry data 635); TIS-B (e.g., non-ADS-B out aircraft telemetry data 635); FIS-B; TCAS (e.g., targets, plus preventive and/or corrective alerts/maneuvers); weather and/or environmental sensing data (e.g., wind speed, temperature, pressure, humidity, turbulence, etc.); audio feed data from ATC VHF communication systems; and/or any other externally sensed data and/or associated sensor configuration information. In some implementations, the telemetry data 635 can include aircraft systems data indicative of the configuration and state of the aerial vehicle such as, for example, an amount of fuel/charge remaining onboard, control-related data (e.g., throttle setting, flap configuration, engine RPMs, etc.) maintenance- or health-monitoring-related data, weight/balancing information, and/or any other internally sensed data and/or associated sensor configuration information.

The device specific secondary vehicle information can be indicative of secondary vehicle information 645 associated with the aerial vehicle such as, for example, external sensor data indicative of one or more environmental conditions, internal sensor data indicative of one or more interior (e.g., vehicle cabin) conditions within a vehicle cabin of the aerial vehicle, payload data indicative of a weight carried beyond an aircraft empty mass associated with the aerial vehicle, and/or any other data associated the aerial vehicle and/or a transportation service. The payload data, for example, can be indicative of one or more passengers and/or cargo carried by the aerial vehicle. The device specific secondary vehicle information can be formatted according to the aerial device format corresponding to the aerial vehicle device 440C that provided the communication 630.

The device specific communication field(s) can be indicative of one or more communication fields 640 formatted according to the aerial device format corresponding to the aerial vehicle device 440C that provided the communication 630. For example, the device specific communication field(s) can include a device specific vehicle identifier indicative of the aerial vehicle device 440C. In addition, or alternatively, the device specific communication field(s) can include fields indicative of at least one of a message version, a message identifier (e.g., to identify duplicate messages, etc.), a message source (e.g., a device, such as the aerial vehicle device 440C, that generated and/or provided the message, etc.), one or more timestamps (e.g., an expiration timestamp, collection timestamp, etc.), an operation identifier (e.g., identifying an operation (e.g., flight, route, route subroutine, etc.) associated with the communication 630), one or more priority(s), and/or any other field representing information associated with the aerial vehicle device 440C.

For example, the communication field(s) 640 can include timestamp(s). The timestamp(s) can include at least one of a sending timestamp indicative of a time at which the communication 630 was sent, a generation timestamp indicative of a time at which the communication 630 was delivered, etc. In addition, or alternatively, in some implementations, the timestamp(s) can include an expiration timestamp and/or a collection timestamp. The expiration timestamp can be indicative of a time at which the information provided by the communication 630 is no longer valid. The collection timestamp can be indicative of a time at which the communication 630 was harvested.

In addition, the communication field(s) 640 can include priority(s). The priority(s) can be indicative of an order in which the communication will be processed (e.g., by the vehicle integration interface 605). For example, the vehicle integration interface 605 (and/or one or more endpoints thereof) can include one or more reception and/or transmission communication queue(s).

The communication 630 can include battery data, pilot data, flight maneuver metrics, sensor data, and/or any data associated with an aerial vehicle and/or the environment within which the aerial vehicle operates. The battery data, for example, can include one or more battery parameters that can be used to determine and/or predict a capability (e.g., range) of the aerial vehicle, a power expenditure of the vehicle, etc. The pilot data can be indicative of a pilot flight time and/or one or more pilot related characteristics (e.g., an expected and/or actual flight time, a level of precision of flight maneuvers, etc.) associated with the operation of an aerial vehicle. The flight maneuver metrics can be indicative of one or more vehicle related characteristics associated with a maneuver of an aerial vehicle. The flight maneuver metrics, for example, can be indicative of a power expenditure, a turning radius, etc. used by an aerial vehicle to complete one or more vehicle maneuvers. The sensor data can include environmental data such as wind information, weather information, noise levels, etc. of an environment within which the aerial vehicle operates. In some implementations, the sensor data can be recorded using one or more sensors onboard the aerial vehicle. The battery data, pilot data, flight maneuver metrics, and/or sensor data can include information from a plurality of devices onboard the aerial vehicle that are configured to record and transmit data using various different syntaxes, data formats, etc.

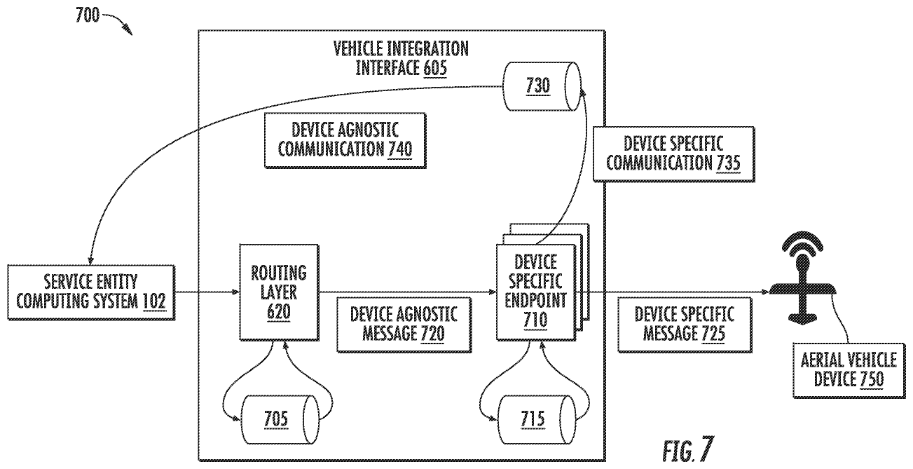

As an example, FIG. 7 depicts an example communication data flow diagram 700 according to example embodiments of the present disclosure. The communication data flow diagram 700 includes the service entity computing system 102, the routing layer 620 and a device specific endpoint 710 of the vehicle integration interface 605, and an aerial vehicle 750. The vehicle integration interface 605 can include one or more reception queue(s) 730 and/or transmission queue(s) 705, 715. The reception queue(s) 730 can include one or more data structure(s) configured to receive and/or store a plurality of communications (e.g., communication 630) before the communications are processed by the vehicle integration interface 605. The reception queue(s) 730 can include an endpoint reception queue corresponding to each endpoint of the vehicle integration system 605, a reception queue for one or more of the endpoints, and/or an overall reception queue for every communication received from each of the plurality of endpoints. The reception queue(s) 730 can include one or more priority queue(s) in which the plurality of communications are ordered according to the priority(s) associated with each respective communication. In some implementations, a communication from the reception queue(s) 730 can be processed based on the priority(s) of the communication and/or a pending time period. The priority(s), for example, can be determined by the aerial vehicle 750 (e.g., aerial vehicle device according to one or more priority standards) based on the contents (e.g., telemetry data 635, secondary vehicle information 645, communication fields 640 of FIG. 6) of the communication.

In addition, or alternatively, the priority(s) can be determined based on the endpoint 710 corresponding to the communication. For example, as discussed herein, each endpoint can correspond to one or more device(s). The priority(s) can be determined based, at least in part, on the one or more device(s) corresponding to each endpoint. For example, the priorities can be determined based on an accuracy, consistency, and/or information associated with the device(s) corresponding to an endpoint. For instance, an endpoint associated with navigational devices associated with a low accuracy can be associated with a lower priority than an endpoint associated with an onboard vehicle computing system associated with a high accuracy. As another example, an endpoint associated with vehicle provider devices associated with service assignment information (e.g., devices configured to request a vehicle service assignment, etc.) can be associated with a lower priority than the endpoint associated with the onboard vehicle computing system associated with accuracy telemetry information. In this manner, the vehicle integration interface 605 can receive and/or process communication(s) in a certain order to avoid processing overload, while prioritizing certain communications for processing based on the accuracy and/or the information typically provided by the communication(s).

The service entity computing system 102 (e.g., the vehicle integration interface 605) can determine an aerial vehicle device 750 corresponding to a device specific communication 735 (e.g., communication 630) based, at least in part, on an endpoint 710 by which the communication 735 was received. For example, as described herein, each endpoint (e.g., of endpoints 615A-D) of the vehicle integration interface 605 can facilitate communication between the service entity computing system 102 and a subset of the aerial vehicle device(s) that are associated with a respective device provider, device type, and/or an aerial device format used by the subset of aerial vehicle device(s). The computing system can identify an aerial device format corresponding to the communication based, at least in part, on the endpoint. In addition, or alternatively, the service entity computing system 102 can determine a device provider and/or type (and/or a corresponding aerial vehicle device 750) that is associated with the communication 735 based on the subset of aerial vehicle device(s), device provider, and/or device type corresponding to the endpoint 710. In some implementations, for example where the communication 735 includes a source field, the aerial vehicle device 750 corresponding to the communication 735 can be determined based on the endpoint 710 and confirmed/validated by the source field. For example, the endpoint 710 can identify the device provider/device type, the service entity computing system 102 can use its knowledge of the device provider/device type to translate the communication 735 to a service entity format (e.g., device agnostic communication 740), and the translated source field can be used to determine and/or verify the aerial vehicle device 440C.

By way of example, the service entity computing system 102 can generate a device agnostic communication 740. The device agnostic communication 740 can include device agnostic telemetry data, secondary vehicle information, and/or communication fields. The service entity computing system 102 can generate the device agnostic communication 740 (e.g., device agnostic telemetry data, secondary vehicle information, communication fields, etc.) based on the device specific communication 735 (e.g., device specific telemetry data, secondary vehicle information, communication fields, etc.) and the aerial vehicle device 750. The device agnostic telemetry data, for example, can be indicative of the telemetry data (e.g., telemetry data 635) for the aerial vehicle in a different format than the device specific telemetry data. For example, the device specific telemetry data can include the telemetry data 635 formatted according to an aerial device format corresponding to the aerial vehicle device 750. As described above, the aerial device format can include one of a plurality of different aerial device formats associated with a number of different aerial vehicle devices. The device agnostic telemetry data can include the telemetry data formatted according to a service entity format corresponding to the service entity associated with the number of different aerial vehicle devices.

The service entity computing system 102 can translate the telemetry data and/or other data (e.g., secondary vehicle information, communication fields, etc.) included in the device specific communication 735 to the service entity format based on the aerial vehicle device 750. For example, the vehicle integration interface 605 can be configured to apply a data conversion function to the device specific communication 735 to translate the device specific communication 735 (e.g., telemetry data, secondary vehicle information, communication fields, etc.) from a device specific format to a device agnostic format. The service entity computing system 102 (e.g., vehicle integration interface 605) can determine a data conversion function for the device specific telemetry data (and/or other components of the device specific communication 735) based on the aerial vehicle device 750. The data conversion function can correspond to the aerial device format of the aerial vehicle device 750. The service entity computing system 102 (e.g., vehicle integration interface 605) can generate the device agnostic communication 740 (e.g., telemetry data, secondary vehicle information, communication fields, etc.) based on the conversion function. For example, the conversion function can be applied to the device specific communication 735 to convert the content of the device specific communication 735 to the service entity format.

The service entity computing system 102 can update a vehicle model corresponding to the aerial vehicle associated with the aerial vehicle device 750 based on the device agnostic telemetry data and/or other data included in the device agnostic communication 740. For example, with reference to FIG. 4, the service entity computing system 102 can maintain a plurality of vehicle models 420. The vehicle models 420 can include at least one vehicle model for each aerial vehicle (e.g., aerial vehicles 405, 450). The vehicle models 420 can include aggregated vehicle data 425 for the aerial vehicle in a device agnostic format. Each aerial vehicle can be associated with a corresponding vehicle model from the plurality of vehicle models 420. Each vehicle model 420 can correspond to an aerial vehicle associated with the service entity (e.g., service entity vehicles 405, third-party vehicles 450, etc.). For example, each of the plurality of vehicle models 420 can correspond to an aerial vehicle utilized to facilitate the multi-modal transportation network.

The vehicle models 420 can include real-time information for an aerial vehicle. The vehicle model, for example, can be indicative of a vehicle state 430 for the aerial vehicle. The vehicle state 430 can be indicative of a current location, a current energy level (e.g., one or more battery parameters), a current route, a current health, a current configuration, and/or any other information associated with the current state of the aerial vehicle.

In addition, or alternatively, the vehicle models 420 can include logged information including information recorded and maintained over time. The logged information, for example, can include vehicle maintenance data logged over time to detect one or more vehicle faults. The vehicle maintenance data any information correlative to the long term and/or short term health. For example, vehicle maintenance data can include battery data collected over time to evaluate the state of a battery of an aerial vehicle. As another example, the vehicle maintenance data can include flight maneuver metrics such as, for instance, a power consumption of a vehicle maneuver over time that can be used to quantify wear and tear of an aerial vehicle. For instance, the vehicle maintenance data can include flight maneuver metrics logged over time to detect an increased power consumption of a flight maneuver and/or other abnormality indicative of the gradual degradation of one or more vehicle components. In addition, or alternatively, the logged information can include pilot data logged over time to facilitate vehicle operator compliance with one or more aerial vehicle standards. In some implementations, the pilot data can be used to standardize one or more vehicle maneuvers for training purposes. In some implementations, the logged pilot data can be used in conjunction with the vehicle maintenance data to determine whether an aerial vehicle could use maintenance.

Turning back to FIG. 6, the service entity computing system 102 can generate a device agnostic vehicle identifier (e.g., by applying the conversion function to the communication fields, etc.) based on the device specific vehicle identifier and the aerial vehicle device 440C. The service entity computing system 102 can identify a vehicle model 650 associated with a respective aerial vehicle associated with the aerial vehicle device 440C based on the device agnostic vehicle identifier. The vehicle model 650 can be updated based, at least in part, on telemetry data 635 received, via the endpoints 440A-E of the vehicle integration interface 605, from a plurality of aerial vehicle devices 440A-E associated with the respective aerial vehicle. For example, the service entity computing system 102 can receive communications, such as communication 630, via the vehicle integration interface 605, from the plurality of different aerial vehicle devices 440A-E (e.g., of different device provider/types, etc.) and update the vehicle model 650 based on the content (e.g., telemetry data 630, secondary vehicle information 645, communication fields 640, etc.) of each of the communications.

In this manner, the service entity computing system 102 can aggregate data from a plurality of different devices 440A-E (e.g., configured to communicate/operate according to a number of different formats, syntaxes, etc.) associated with a respective aerial vehicle to maintain a vehicle model 650 representative of the current state of the respective aerial vehicle. For example, the telemetry data 635 can be indicative of at least one of a location update, a route update, a power update, a health update, and/or a configuration update for the respective aerial vehicle. One or more of the updates indicated by the telemetry data can be applied to the vehicle model 650 to update one or more of the aspects of the vehicle state. As an example, the telemetry data 635 can be indicative of a current location of the respective aerial vehicle as identified by one or more navigation device(s) (e.g., associated with a first device provider/type) onboard the respective aerial vehicle, an aerial vehicle computing system (e.g., associated with a second device provider/type), and/or any other device associated with the respective aerial vehicle. In such a case, the location of the vehicle model 650 corresponding to the respective aerial vehicle can be updated based on the current location of the aerial vehicle as identified by the plurality of different devices 440A-E.

The service entity computing system 102 can initiate one or more vehicle action(s) for an aerial vehicle based on a corresponding vehicle model 650. The vehicle action(s) can be initiated to facilitate a transportation service. For example, the vehicle action(s) can include at least one of a routing action, an assignment action, and/or a servicing action for the aerial vehicle. By way of example, the service entity can be configured to communicate (e.g., via the vehicle integration interface 605) with one or more aerial vehicle device(s) 440A-E (e.g., configured to communicate/operate according to a number of different formats, syntaxes, etc.) to provide one or more message(s) 610A-C to initiate a vehicle action. In this manner, the service entity computing system 102 can utilize a vehicle integration interface 605 to provide routing, servicing, and/or any other information associated with a transportation service to an aerial vehicle associated with one or more different communication standards.

More particularly, the service entity computing system 102 can generate a message 610A for an aerial vehicle that can be tailored for an aerial vehicle device 440C associated with the aerial vehicle. The message 610A can include a routing request 655 and/or an informational message 650. For instance, the message 610A can be associated with one or more message type(s). The message type(s) can be indicative of a content of the message 610A. For example, the message types can include one or more informational message types (e.g., informational message 650), one or more routing request types 655 (e.g., routing request 655), and/or any other types of messages for facilitating an aerial transportation leg of a multi-modal transportation service. As an example, an informational message 650 of an informational message types can include aerial transportation service(s) data 660 such as, for example, a passenger manifest, environmental data (e.g., expected weather conditions, wind speeds, etc.), air space information (e.g., skylane traffic, etc.) and/or any other data associated with a transportation service. As one particular example, the informational message 650 can include battery data associated with one or more power sources of an aerial vehicle. For example, battery data can be indicative of a battery capability and/or one or more parameters for determining a capability (e.g., range, etc.) of a battery onboard an aerial vehicle. The one or more parameters, for example, can include an expected vehicle weight, altitude, temperature at a landing and/or take-off zone, etc. In some implementations, the one or more parameters can be provided (e.g., via an informational message 650) in a device specific format for representation to a pilot of the aerial vehicle and/or for use in determining a battery capability onboard the aerial vehicle.

As another example, a route request 655 of a route request type can include routing data 665. The route request 655, for example, can include a route change type (e.g., a modification to a current or scheduled route), a contingency route type (e.g., a request to follow and/or alter contingency plan), a time of arrival type (e.g., a request to complete a flight by a time deadline), a procedure type (e.g., indicative of a route procedure), and/or a frequency type (e.g., a time period for sending and/or receiving telemetry data during the performance of a route). In some implementations, the message 610A can include a route request 655 that is at least one of the route request types.

The service entity computing system 102 can generate a routing request 655 based on routing data 665. For example, the service entity computing system 102 can obtain routing data 665 for an aerial vehicle associated with an aerial vehicle device 440C. The routing data 665 can include one or more aerial procedures. Each aerial procedure can include a route (and/or portion thereof), one or more altitude and/or speed constraints, and/or metadata indicative of suggested pilot behaviors for performing the aerial procedure. The aerial procedure(s) can include a departure procedure indicative of a route (and/or portion thereof) for departing from an aerial transportation facility, an arrival procedure indicative of a route (and/or portion thereof) for arriving at an aerial transportation facility, an approach procedure indicative of a route (and/or portion thereof) for approaching an aerial transportation facility, and/or an en-route procedure indicative of a route (and/or portion thereof) between two aerial transportation facilities.

The service entity computing system 102 can obtain and/or generate a sequence of procedures to be followed for a route. For example, in some implementations, the procedure(s) can include one or more of a plurality of predefined (and/or preapproved) route sequences. In such a case, the service entity computing system 102 can determine a route for an aerial vehicle and obtain one or more procedure identifiers for the route. The predefined procedures can be preloaded into one or more of the aerial vehicle device(s) 440A-E (e.g., a vehicle computing system onboard an aerial vehicle, etc.) such that a route can be assigned to an aerial vehicle by providing the procedure identifier(s) for the route to the aerial vehicle device(s) 440A-E. In addition, or alternatively, the service entity computing system 102 can dynamically generate one or more procedure(s) and provide routing data indicative of the procedure(s) to the aerial vehicle device(s) 440A-E.

In some implementations, the routing data 665 can include one or more contingency plans for one or more phases of a route. The contingency plan(s) can be indicative of a route plan for one or more potential contingencies at one or more times during a flight. The contingency plan(s) can include a plurality of contingency plans, the selection of which can be based on the nature and/or immediacy of a contingency. A contingency plan, for example, can include an action to continue to a nominal landing site, divert to a known and/or approved backup landing site, divert to a relatively safe landing site that may not have been preapproved for emergency landing, and/or land immediately in the safest possible location.

At times, the routing data 665 can include one or more time thresholds. The one or more time thresholds can include a requested time of arrival for an aerial vehicle. For example, the requested time of arrival can be provided to an aerial vehicle to delegate responsibility for monitoring and/or implementing tactical speed adjustments to meet a desired arrival time. In addition, or alternatively, the routing data 665 can include in-trail aircraft data indicative of an aircraft to track and follow along with a parameter specifying a following interval. Moreover, the routing data 665 can include frequency information indicative of a frequency not typically used in routine operations. Frequency information, for example, can include a frequency at which an aerial traffic controller can verbally communicate with one or more operators of the aerial vehicle.

The service entity computing system 102 can generate a routing request 655 for the aerial vehicle based on the aerial vehicle device 440B and the routing data 665. The routing request 655 can include one or more routing commands, routing requirements, routing acknowledgements, routing targets, and/or any other data associated with a transportation service. By way of example, the routing request 655 can be indicative of one or more route changes and/or trip assignments. For instance, the routing request 655 can include a specification of a new route for the aerial vehicle. The new route can be indicative of a transportation service for completing an aerial portion of a multi-modal transportation service.

In some implementations, the service entity computing system 102 can generate the routing request 655 based on the vehicle model 650 associated with the aerial vehicle and/or multi-modal transportation services data associated with a multi-modal transportation platform. For example, the routing request 655 can be generated based on multi-modal transportation services data indicative of a plurality of requests for a multi-modal transportation service. By way of example, the routing request 655 can be generated to facilitate an aerial transportation leg of a multi-modal transportation itinerary. As discussed herein, the routing request 655 can be provided, via vehicle integration interface 605, to an aerial vehicle device 440C associated with the aerial vehicle to initiate the performance of the aerial transportation leg of the multi-modal transportation itinerary.

In addition, or alternatively, the routing request 655 can be generated based on the vehicle model 650 corresponding to the aerial vehicle. For instance, the service entity computing system 102 can obtain a vehicle model 650 corresponding to the aerial vehicle. The vehicle model 650 can include vehicle data (e.g., aggregated from a plurality of different aerial vehicle devices) for the aerial vehicle in a device agnostic format. The service entity computing system 102 can assign an aerial transportation leg of the multi-modal transportation itinerary to the aerial vehicle and, in response, generate the routing request 655 for the aerial vehicle, based on the vehicle model 650. For example, the service entity computing system 102 can determine that the aerial vehicle is available to provide the aerial transportation service (e.g., based on a flight state represented by the vehicle model 650), located proximate to a departure facility for the aerial transportation service (e.g., based on the current location represented by the vehicle model 650), has a power level required to perform the aerial transportation service (e.g., based on the energy level represented by the vehicle model 650), etc.

In some implementations, the routing request 655 can include a request to change a current route of the aerial vehicle. For example, the service entity computing system 102 can generate a routing request 655 indicative of a modified route to augment an aerial vehicle's and/or aerial vehicle operator's situational awareness. The routing request 655, for example, can include a suggested route modification (and/or one or more route procedures) for an operator of the aerial vehicle. The operator can review and select the suggested route to approve the modification (and/or assignment).

The routing request 655 can indicate a flight segment associated with one or more passengers (e.g., of the multi-modal transportation service). The routing request 655 can include a command (e.g., for one or more service entity vehicles) and/or a request (e.g., for one or more third-party vehicles) to perform an aerial transportation leg of a multi-modal transportation service. In some implementations, the service entity computing system 102 can log each of a plurality of routing requests. In this way, the service entity computing system can have full awareness of transmission and execution of routing requests uplinked to the aerial vehicle devices 440A-E.

Turning to FIG. 7, the service entity computing system 102 can provide a message 720 (e.g., routing request 655, informational message 650, etc.) to the vehicle integration interface 605 (e.g., the routing layer 630). The service entity computing system 102 (e.g., the routing layer 630) can determine an endpoint 710 of the vehicle integration interface 605 for providing the message 720 (e.g., routing request) to an aerial vehicle. For example, the service entity computing system 102 can determine an aerial vehicle device 750 (e.g., vehicle computing system, operator device, etc.) associated with the aerial vehicle. The service entity computing system 102 can determine the endpoint 710 based, at least in part, on the aerial vehicle device 750. By way of example, the endpoint 710 can include one of a plurality of endpoints (e.g., endpoints 615A-D) of the vehicle integration interface 605 associated with the service entity. The endpoint 710 can include the endpoint 710 of the plurality of endpoints that corresponds to the aerial vehicle device 750 (and/or the associated device provider/type or aerial device format). By way of example, the endpoint 710 can include an endpoint assigned to the aerial vehicle device 750 during an onboarding process for the aerial vehicle device 750. In some implementations, the endpoint 710 can correspond to one or more different aerial devices that use a respective aerial device format.

The service entity computing system 102 can provide, via the endpoint 710 of the vehicle integration interface 605, the message 720 (e.g., informational message 650, routing request 655, etc.) to the aerial vehicle device 750. In some implementations, the service entity computing system 102 can translate the message 720 (e.g., informational message, routing request, etc.) before providing the message 720 (e.g., informational message, routing request, etc.) to the aerial vehicle device 750. For example, the message 720 (e.g., informational message, routing request, etc.) can be formatted according to a device agnostic format. For instance, a routing request can include one or more instructions (e.g., command, request, etc.) formatted according to the device agnostic format. The service entity computing system 102 (e.g., device specific endpoint 710) can identify a device specific format corresponding to the aerial vehicle device 750 (e.g., based on the device provider/type), obtain a data conversion function for the device specific format, and translate the device agnostic message 720 (e.g., instruction(s) and/or one or more other component(s) of a routing request, information message, etc.) to the device specific format (e.g., syntax, message format, data format, etc.) using the data conversion function. The service entity computing system 102 can provide, via the endpoint 710 of the vehicle integration interface 605, the resulting device specific message 725 (e.g., device specific routing request, device specific informational message, etc.) such that the aerial vehicle device 750 can accurately process the translated contents of the message 725.

In some implementations, the vehicle integration interface 605 can include one or more transmission queue(s) 705, 715 for storing a plurality of messages (e.g., informational messages, routing requests, etc.) before the transmission of each of the messages (e.g., informational messages, routing requests, etc.) to a respective aerial vehicle device 750. The transmission queue(s) 705, 715 can include a routing transmission queue 705 in which messages can be queued before being routed to a respective device specific endpoint 710 and an endpoint transmission queue 715 in which messages can be queued before being provided to a respective aerial vehicle device 750.

The transmission queue(s) 705, 715 can include one or more priority queues configured to transmit a message 720, 725 (e.g., informational message, routing request, etc.) based on a priority and/or a function of time associated with the message 720, 725 (e.g., informational message, routing request, etc.). For example, messages (e.g., informational messages, routing requests, etc.) can be provided to a plurality of different aerial vehicles in parallel, the respective aerial vehicle devices can be working with constrained bandwidths to receive communications, and/or the service entity computing system 102 can provide multiple routing requests at once in a certain order. In such a case, the service entity computing system 102 can assign a priority to each of the messages (e.g., informational messages, routing requests, etc.). The transmissions queue(s) 705, 715 can store the messages according to their priority and send a respective message based on the priority assigned to the message.

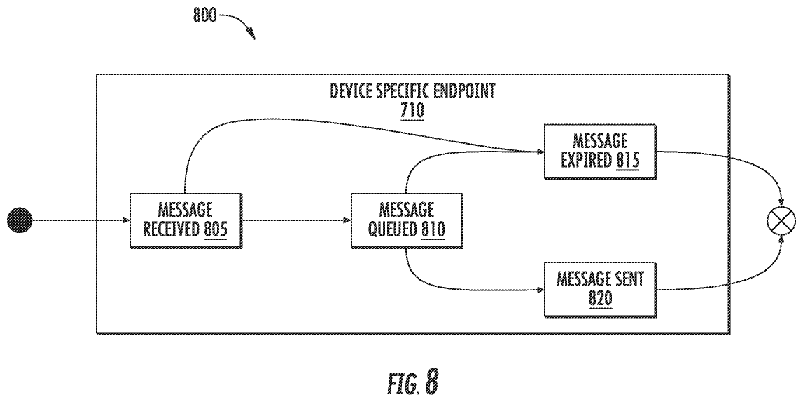

For example, FIG. 8 depicts an example messaging queue process 800 according to example embodiments of the present disclosure. The messaging queue process 800 includes one or more steps provided by the vehicle integration interface 605 and/or a device specific endpoint 710 thereof. At (805), a message can be received. At (810), the message can be queued and at (815) the message can become expired. At (820), the message can be transmitted to a respective aerial vehicle device.

More particularly, a message (e.g., informational message, routing request, etc.) can include an expiration time limit. In the event that the expiration time limit is achieved before the message is provided to a respective aerial vehicle device, the message can be ignored and not sent to the aerial vehicle device. For example, after a message is received (e.g., by a device specific endpoint 710, routing layer 620, etc.) the message can be analyzed to determine whether an expiration time limit associated with the message was reached. The message can become expired, at (815), in the event that the expiration time limit has been reached. In addition, or alternatively, the message can be queued, at (810), in the event that the expiration time limit has not been reached. After the message is next in the queue the message can be analyzed to determine whether an expiration time limit associated with the message has been reached. The message can become expired, at (815), in the event that the expiration time limit has been reached. In addition, or alternatively, the message can be provided, at (820), in the event that the expiration time limit has not been reached. In some implementations, the service entity computing system can postpone translating the message until the message is ready (e.g., next in the queue, etc.) for transmission and the expiration time limit has not been reached.

Turning back to FIG. 6, in some implementations, the service entity computing system 102 (e.g., routing layer 620) can filter the messages 610A-C (e.g., informational messages 650, routing requests 655, etc.) based on the appropriateness of the messages 610A-C (e.g., informational messages 650, routing requests 655, etc.) for transmission to an aerial vehicle device 440C. For example, the service entity computing system 102 can determine whether the data flowing through the vehicle integration interface 605 is permissible and/or appropriate (e.g., commands may not be capable of being sent to vehicles at all times) based on the vehicle model 650 corresponding to the aerial vehicle associated with the aerial vehicle device 440C.

By way of example, the service entity computing system 102 can assume the permissibility and/or appropriateness to provide messages 610A-C (e.g., informational messages 650, routing requests 655, etc.) to one or more aerial vehicles.

As another example, the service entity computing system 102 can determine whether the messages 610A-C (e.g., informational messages 650, routing requests 655, etc.) are appropriate based on the flight state and/or flight schedule of the aerial vehicle (e.g., as represented by the vehicle model 650). By way of the example, the messages 610A-C (e.g., informational messages 650, routing requests 655, etc.) can be permissible in the event that the flight state and/or flight schedule is indicative of a preflight, after landing, or parked/charging state, etc.

As another example, the service entity computing system 102 can determine whether the messages 610A-E (e.g., informational messages 650, routing requests 655, etc.) are appropriate based on the vehicle state (e.g., battery level, etc.) of the aerial vehicle (e.g., as represented by the vehicle model 650). For example, the messages 610A-C (e.g., informational messages 650, routing requests 655, etc.) can be impermissible in the event that the aerial vehicle cannot complete a route/route modification based on low power level, etc. as represented by the vehicle model 650.

As another example, the service entity computing system 102 can predict whether the messages 610A-C (e.g., informational messages 650, routing requests 655, etc.) are appropriate based on a history of vehicle states as represented by the vehicle model 650 (e.g., previous phase logic (e.g., state data), current states (vehicle, flight, or other), history of current states, etc.).

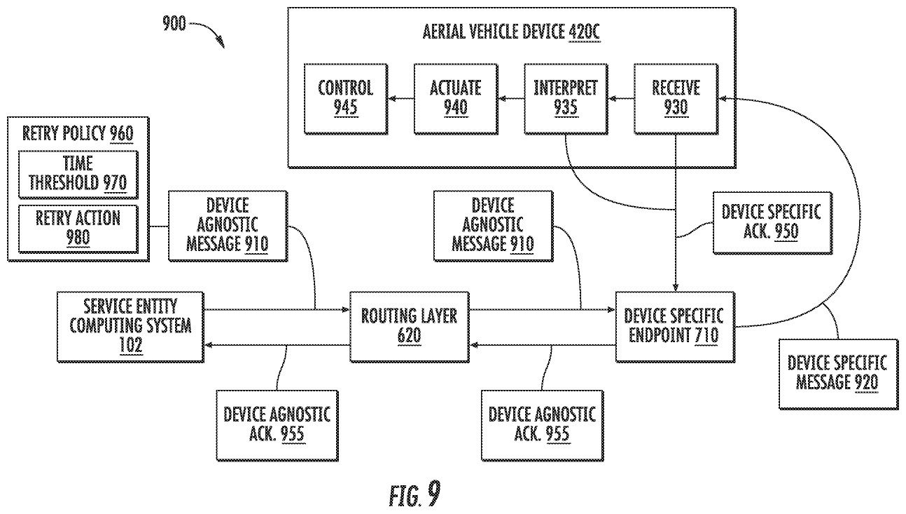

Turning to FIG. 9, FIG. 9 depicts an end-to-end communication data flow diagram 900 according to example embodiments of the present disclosure. The diagram 900 includes the service entity computing system 102, routing layer 620, device specific endpoint 710, and aerial vehicle device 420C. The service entity computing system 102 can provide a message 910 to the aerial vehicle device 420C via the routing layer 620 and device specific endpoint 710 of the vehicle integration interface. In some implementations, the message 910 (e.g., informational messages, routing requests, etc.) can be associated with a retry policy 960. The retry policy 960 can be indicative of time threshold 970 and/or a retry action 980. By way of example, the message 910 (e.g., informational message, routing request, etc.) can include an acknowledgement request. The acknowledgement request can include a request for an acknowledgement message (e.g., acknowledgement messages 950, 955) to verify that the aerial vehicle device 420C has received the message 910, 920 (e.g., informational message, routing request, etc.) and/or is initiating a command and/or request of a routing request.

The service entity computing system 102 can provide the device agnostic message 910 to the routing layer 620 and/or device specific endpoint 710 of the vehicle integration interface. The service entity computing system 102 can translate (e.g., at the device specific endpoint 710, etc.) the device agnostic message 910 to the device specific message 920 and provide the device specific message 920 (with a request for an acknowledgement) to the aerial vehicle device 420C. The aerial vehicle device 420C can receive, at (930), the device specific message 920, interpret, at (935), the message 920, and actuate, at (940) one or more aerial vehicle computing systems to control, at (945), an aerial vehicle in response to the message 920. The aerial vehicle device 420C can be configured to provide a device specific acknowledgement 950 to the service entity computing system 102 (e.g., via the device specific endpoint 710) in response to receiving, at (935), the device specific message 920. In addition, or alternatively, the aerial vehicle device 420C can be configured to provide the device specific acknowledgement 950 to the service entity computing system 102 (e.g., via the device specific endpoint 710) in response to accurately interpreting, at (935), the device specific message 920.

The service entity computing system 102 can obtain an elapsed time indicative of a time period after the message 920 (e.g., informational message, routing request, etc.) is provided to the aerial vehicle device 420C and/or before an acknowledgement 950 is received from the aerial vehicle device 420C. In response to the elapsed time achieving the time threshold 970 of the retry policy 960 associated with the message 910, 920 (e.g., informational message, routing request, etc.), the service entity computing system 102 can initiate the retry action 980. The retry action 980, for example, can include providing a second routing request to the aerial vehicle device 420C, initiating one or more safety action(s) (e.g., notifying an operator, provider, etc. of the associated aerial vehicle/device, etc.), providing another routing request to another aerial vehicle device associated with the aerial vehicle, etc.

The retry policy 960 can be determined for the message 910, 920 (e.g., routing request) based on the message type (e.g., route request type, etc.), the aerial vehicle, and/or the aerial vehicle device 420C. As an example, the retry policy 960 can be tailored to one or more aspects of the message 910, 920 (e.g., routing request). As an example, the retry policy 960 can include a retry action 980 based on the route request type. By way of example, the retry action 980 can include not issuing another routing request for route requests indicative of a minor flight modification (e.g., suggested alternate route to avoid minor turbulence, etc.), issuing another routing request for route requests indicative of a flight assignment, issuing multiple additional route requests for route requests indicative of a contingency plan, etc.

In addition, or alternatively, the frequency (e.g., time threshold 970) of the retry policy 960 can be tailored to the route request type and/or aerial vehicle device 420C. For example, the time threshold 970 for the retry policy 960 can be determined based on historical acknowledgement data associated with the aerial vehicle device 420C. In this manner, the time threshold 970 for the retry policy 960 can be based on an expected acknowledgement time for the respective aerial vehicle device 420C. As another example, time threshold 970 can be determined based on the route request type. By way of example, the time threshold 970 can include a longer time threshold for route requests indicative of a minor flight modification (e.g., suggested alternate route to avoid minor turbulence, etc.) as compared to route requests indicative of a contingency plan, etc. As yet another example, the time threshold 970 and/or retry action 980 can be determined based on a message priority associated with the message 910, 920 (e.g., routing request). For instance, a retry action 980 and/or time threshold 970 can include one or more second routing requests for high priority routing requests, a shorter time threshold for high priority routing requests, no second routing request for low priority routing request, and/or a longer time threshold for low priority routing requests.

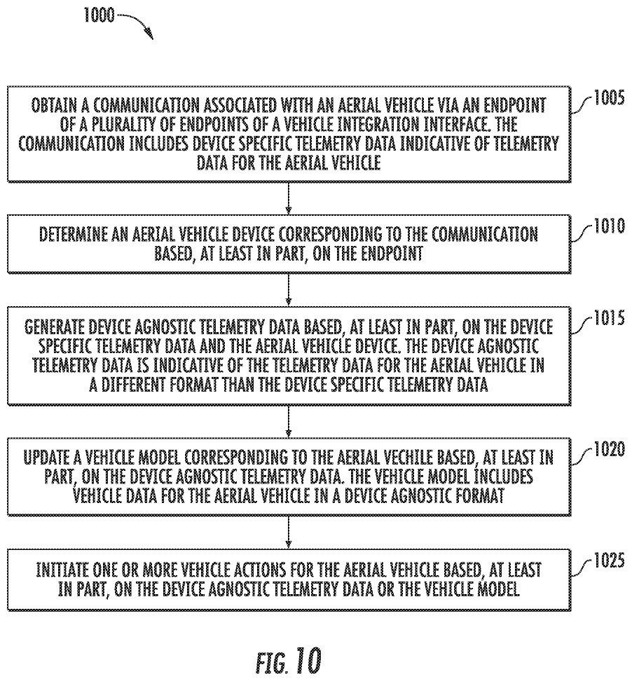

Turning to FIG. 10, FIG. 10 depicts a flow chart diagram for an example method 1000 of obtaining telemetry data from an aerial vehicle device according to example embodiments of the present disclosure. One or more portion(s) of the method 1000 can be implemented by a computing system that includes one or more computing devices such as, for example, the computing systems described with reference to the other figures (e.g., service entity computing system 102, vehicle integration interface 605, aerial vehicle device(s) 440A-E, etc.). Each respective portion of the method 1000 can be performed by any (or any combination) of one or more computing devices. Moreover, one or more portion(s) of the method 1000 can be implemented as an algorithm on the hardware components of the device(s) described herein (e.g., as in FIGS. 1, 4, 6-9, 12, etc.), for example, to obtain information from different aerial device(s). FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 10 is described with reference to elements/terms described with respect to other systems and figures for exemplary illustrated purposes and is not meant to be limiting. One or more portions of method 1000 can be performed additionally, or alternatively, by other systems.

At 1005, the method 1000 can include obtaining a communication associated with an aerial vehicle via an endpoint of a plurality of endpoints of a vehicle integration interface. For example, a computing system (e.g., service entity computing system 102, vehicle integration interface 605, etc.) can obtain the communication associated with the aerial vehicle via the endpoint of the plurality of endpoints of the vehicle integration interface. The communication can include device specific telemetry data indicative of telemetry data for the aerial vehicle.

At 1010, the method 1000 can include determining an aerial vehicle device corresponding to the communication based, at least in part, on the endpoint. For example, the computing system (e.g., service entity computing system 102, vehicle integration interface 605, etc.) can determine the aerial vehicle device corresponding to the communication based, at least in part, on the endpoint.

At 1015, the method 1000 can include generating device agnostic telemetry data based, at least in part, on the device specific telemetry data and the aerial vehicle device. For example, the computing system (e.g., service entity computing system 102, vehicle integration interface 605, etc.) can generate the device agnostic telemetry data based, at least in part, on the device specific telemetry data and the aerial vehicle device. The device agnostic telemetry data can be indicative of the telemetry data for the aerial vehicle in a different format than the device specific telemetry data.

At 1020, the method 1000 can include updating a vehicle model corresponding to the aerial vehicle based, at least in part, on the device agnostic telemetry data. For example, the computing system (e.g., service entity computing system 102, vehicle integration interface 605, etc.) can update the vehicle model corresponding to the aerial vehicle based, at least in part, on the device agnostic telemetry data. The vehicle model can include vehicle data for the aerial vehicle in a device agnostic format.

At 1025, the method 1000 can include initiating one or more vehicle actions for the aerial vehicle based, at least in part, on the device agnostic telemetry data or the vehicle model. For example, the computing system (e.g., service entity computing system 102, vehicle integration interface 605, etc.) can initiate the one or more vehicle actions for the aerial vehicle based, at least in part, on the device agnostic telemetry data or the vehicle model.

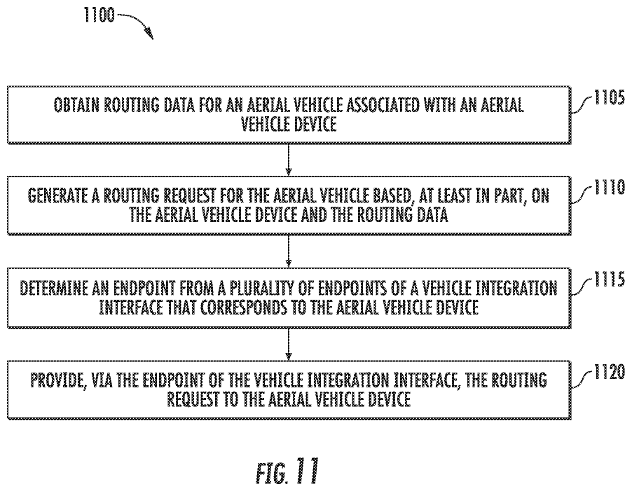

Turning to FIG. 11, FIG. 11 depicts a flow chart diagram of an example method 1100 for providing a routing request to an aerial vehicle device according to example embodiments of the present disclosure. One or more portion(s) of the method 1100 can be implemented by a computing system that includes one or more computing devices such as, for example, the computing systems described with reference to the other figures (e.g., service entity computing system 102, vehicle integration interface 605, aerial vehicle device(s) 440A-E, etc.). Each respective portion of the method 1100 can be performed by any (or any combination) of one or more computing devices. Moreover, one or more portion(s) of the method 1100 can be implemented as an algorithm on the hardware components of the device(s) described herein (e.g., as in FIGS. 1, 4, 6-9, 12, etc.), for example, to provide different messages to different aerial device(s). FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 11 is described with reference to elements/terms described with respect to other systems and figures for exemplary illustrated purposes and is not meant to be limiting. One or more portions of method 1100 can be performed additionally, or alternatively, by other systems.

At 1105, the method 1100 can include obtaining routing data for an aerial vehicle associated with an aerial vehicle device. For example, a computing system (e.g., service entity computing system 102, vehicle integration interface 605, etc.) can obtain the routing data for the aerial vehicle associated with the aerial vehicle device.

At 1110, the method 1100 can include generating a routing request for the aerial vehicle based, at least in part, on the aerial vehicle device and the routing data. For example, the computing system (e.g., service entity computing system 102, vehicle integration interface 605, etc.) can generate the routing request for the aerial vehicle based, at least in part, on the aerial vehicle device and the routing data.

At 1115, the method 1100 can include determining an endpoint from a plurality of endpoints of a vehicle integration interface that corresponds to the aerial vehicle device. For example, the computing system (e.g., service entity computing system 102, vehicle integration interface 605, etc.) can determine the endpoint from the plurality of endpoints of the vehicle integration interface that corresponds to the aerial vehicle device.

At 1120, the method 1000 can include providing, via the endpoint of the vehicle integration interface, the routing request to the aerial vehicle device. For example, the computing system (e.g., service entity computing system 102, vehicle integration interface 605, etc.) can provide, via the endpoint of the vehicle integration interface, the routing request to the aerial vehicle device.

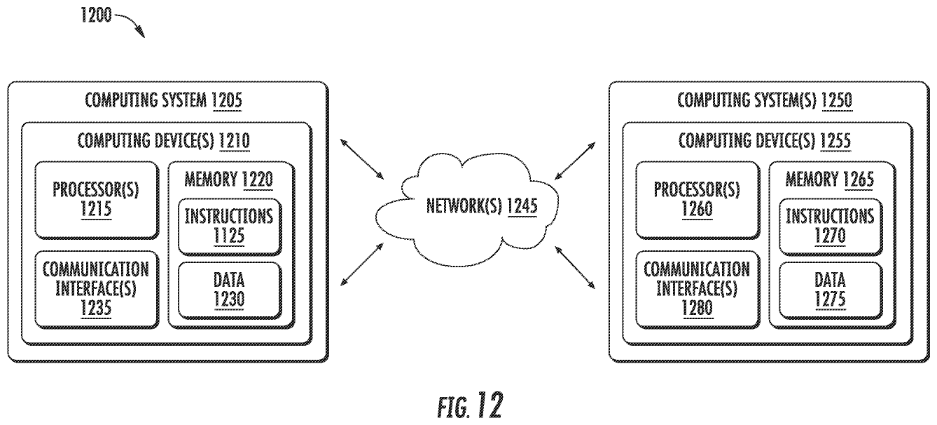

FIG. 12 depicts example system components of an example system 1200 according to example embodiments of the present disclosure. The example system 1200 can include the computing system 1205 (e.g., service entity computing system 102, vehicle integration interface 605, etc.) and the computing system(s) 1250 (e.g., aerial vehicle devices 440A-E, vehicle provider computing system(s) 140, rider computing device(s) 145, service provider computing device(s) 150, 160, 170, infrastructure and operations computing device(s) 190, etc.), etc. that are communicatively coupled over one or more network(s) 1145.

The computing system 1205 can include one or more computing device(s) 1210. The computing device(s) 1210 of the computing system 1205 can include processor(s) 1215 and a memory 1220. The one or more processors 1215 can be any suitable processing device (e.g., a processor core, a microprocessor, an ASIC, a FPGA, a controller, a microcontroller, etc.) and can be one processor or a plurality of processors that are operatively connected. The memory 1220 can include one or more non-transitory computer-readable storage media, such as RAM, ROM, EEPROM, EPROM, one or more memory devices, flash memory devices, etc., and combinations thereof.

The memory 1220 can store information that can be accessed by the one or more processors 1215. For instance, the memory 1220 (e.g., one or more non-transitory computer-readable storage mediums, memory devices) can include computer-readable instructions 1225 that can be executed by the one or more processors 1215. The instructions 1225 can be software written in any suitable programming language or can be implemented in hardware. Additionally, or alternatively, the instructions 1225 can be executed in logically and/or virtually separate threads on processor(s) 1215.

For example, the memory 1220 can store instructions 1225 that when executed by the one or more processors 1215 cause the one or more processors 1215 to perform operations such as any of the operations and functions for which the computing system is configured, as described herein.

The memory 1220 can store data 1230 that can be obtained, received, accessed, written, manipulated, created, and/or stored. The data 1230 can include, for instance, vehicle model data, vehicle state data, aggregated vehicle data, and/or other data/information described herein. In some implementations, the computing device(s) 1210 can obtain from and/or store data in one or more memory device(s) that are remote from the computing system 1205 such as one or more memory devices of the computing system 1250.

The computing device(s) 1210 can also include a communication interface 1235 used to communicate with one or more other system(s) (e.g., computing system 1250). The communication interface 1235 can include any circuits, components, software, etc. for communicating via one or more networks (e.g., 1245). In some implementations, the communication interface 1235 can include for example, one or more of a communications controller, receiver, transceiver, transmitter, port, conductors, software and/or hardware for communicating data/information.

The computing system 1250 can include one or more computing devices 1255. The one or more computing devices 1255 can include one or more processors 1260 and a memory 1265. The one or more processors 1260 can be any suitable processing device (e.g., a processor core, a microprocessor, an ASIC, a FPGA, a controller, a microcontroller, etc.) and can be one processor or a plurality of processors that are operatively connected. The memory 1265 can include one or more non-transitory computer-readable storage media, such as RAM, ROM, EEPROM, EPROM, one or more memory devices, flash memory devices, etc., and combinations thereof.

The memory 1265 can store information that can be accessed by the one or more processors 1260. For instance, the memory 1265 (e.g., one or more non-transitory computer-readable storage mediums, memory devices) can store data 1275 that can be obtained, received, accessed, written, manipulated, created, and/or stored. The data 1275 can include, for instance, vehicle data, telemetry data, secondary vehicle data, and/or other data or information described herein. In some implementations, the computing system 1250 can obtain data from one or more memory device(s) that are remote from the computing system 1250.

The memory 1265 can also store computer-readable instructions 1270 that can be executed by the one or more processors 1260. The instructions 1270 can be software written in any suitable programming language or can be implemented in hardware. Additionally, or alternatively, the instructions 1270 can be executed in logically and/or virtually separate threads on processor(s) 1260. For example, the memory 1265 can store instructions 1270 that when executed by the one or more processors 1260 cause the one or more processors 1260 to perform any of the operations and/or functions described herein, including, for example, any of the operations and functions of the devices described herein, and/or other operations and functions.

The computing device(s) 1255 can also include a communication interface 1280 used to communicate with one or more other system(s). The communication interface 1280 can include any circuits, components, software, etc. for communicating via one or more networks (e.g., 1245). In some implementations, the communication interface 1280 can include for example, one or more of a communications controller, receiver, transceiver, transmitter, port, conductors, software and/or hardware for communicating data/information.

The network(s) 1245 can be any type of network or combination of networks that allows for communication between devices. In some embodiments, the network(s) 1245 can include one or more of a satellite network, local area network, wide area network, the Internet, secure network, cellular network, mesh network, peer-to-peer communication link and/or some combination thereof and can include any number of wired or wireless links. Communication over the network(s) 1245 can be accomplished, for instance, via a network interface using any type of protocol, protection scheme, encoding, format, packaging, etc.

FIG. 12 illustrates one example system 1200 that can be used to implement the present disclosure. Other computing systems can be used as well. Computing tasks discussed herein as being performed at a transportation services system, the simulation computing system, etc. can instead be performed remote from the respective system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method, the method comprising:
obtaining, by the computing system comprising one or more computing devices, a communication associated with an aerial vehicle via an endpoint of a plurality of endpoints communicatively connected to a vehicle integration interface, wherein the communication comprises received telemetry data comprising telemetry data for the aerial vehicle formatted according to an aerial device format;
identifying, by the computing system, an aerial device format corresponding to the communication based, at least in part, on the endpoint;
generating, by the computing system, formatted telemetry data based, at least in part, on the received telemetry data and the device specific format, wherein the formatted telemetry data comprises the telemetry data for the aerial vehicle formatted according to a different format than the device specific format; and
initiating, by the computing system, one or more vehicle actions for the aerial vehicle based, at least in part, on the formatted telemetry data.

2. The computer-implemented method of the claim 1, further comprising:
updating, by the computing system, a vehicle model corresponding to the aerial vehicle based, at least in part, on the formatted telemetry data, wherein the vehicle model comprises formatted vehicle data for the aerial vehicle formatted according to the different format.

3. The computer-implemented method of the claim 2, wherein the vehicle model is indicative of a vehicle state for an aerial vehicle, the vehicle state indicative of a location, energy, route, health, or configuration of the aerial vehicle.

4. The computer-implemented method of the claim 3, wherein the telemetry data is indicative of a location update, a route update, a power update, a health update, or a configuration update for the aerial vehicle.

5. The computer-implemented method of the claim 4, wherein the location update is indicative of the current location of the aerial vehicle, and wherein updating the vehicle model comprises:
updating, by the computing system, the location of the vehicle state based, at least in part, on the current location of the aerial vehicle.

6. The computer-implemented method of the claim 2, wherein the communication is obtained from an aerial vehicle device of a plurality of different aerial vehicle devices, wherein the aerial device format is a data format used by the aerial vehicle device, wherein the different format corresponds to a data format used by a service entity associated with the plurality of aerial vehicle devices.

7. The computer-implemented method of the claim 6, wherein the aerial device format is one of a plurality of different aerial device formats, and wherein each of the plurality of aerial vehicle devices are associated with a respective aerial device format of the plurality of aerial device formats.

8. The computer-implemented method of the claim 6, wherein the service entity is configured to communicate with the plurality of aerial vehicle devices to facilitate a multi-modal ride-sharing network.

9. The computer-implemented method of the claim 8, wherein the vehicle model is one of a plurality of vehicle models, and wherein each of the plurality of vehicle models correspond to a respective aerial vehicle utilized to facilitate the multi-modal ride-sharing network.

10. The computer-implemented method of the claim 9, wherein the communication further comprises a received vehicle identifier, and wherein updating the vehicle model associated with the aerial vehicle comprises:
generating, by the computing system, a formatted vehicle identifier based, at least in part, on the received vehicle identifier and the device specific format; and
identifying, by the computing system, the vehicle model from the plurality of vehicle models based, at least in part, on the formatted vehicle identifier.

11. The computer-implemented method of the claim 1, wherein generating the formatted telemetry data based, at least in part, on the received telemetry data and the aerial vehicle device comprises:
determining, by the computing system, a data conversion function for the received telemetry data based, at least in part, on the device specific format; and
generating, by the computing system, the formatted telemetry data based, at least in part, on the conversion function.

12. One or more tangible, non-transitory computer-readable media storing computer-readable instructions that when executed by one or more processors cause the one or more processors to perform operations, the operations comprising:
obtaining routing data for an aerial vehicle associated with an aerial vehicle device, wherein the routing data is formatted according to a device agnostic format corresponding to a service entity associated with one or more aerial vehicle devices;
generating a routing request for the aerial vehicle based, at least in part, on the aerial vehicle device and the routing data, wherein the routing request comprises the routing data formatted according to an aerial device format corresponding to the aerial vehicle device;
determining an endpoint corresponding to the aerial vehicle device, wherein the endpoint is one of a plurality of endpoints of a vehicle integration interface associated with the service entity, the vehicle integration interface configured to connect with the plurality of endpoints; and
providing, via the endpoint of the vehicle integration interface, the routing request to the aerial vehicle device.

13. The one or more tangible, non-transitory computer-readable media of claim 12, wherein the routing request comprises a request to change a current route of the aerial vehicle.

14. The one or more tangible, non-transitory computer-readable media of claim 12, wherein the routing request is at least one of one or more route request types, the route request types comprising a route change type, a contingency route type, a time of arrival type, a procedure type, or a frequency type.

15. The one or more tangible, non-transitory computer-readable media of claim 14, wherein the routing request is associated with a retry policy, the retry policy indicative of time threshold and a retry action, wherein the retry action comprises providing a second routing request to the aerial vehicle device.

16. The one or more tangible, non-transitory computer-readable media of claim 15, wherein the retry policy is determined based, at least in part, on the route request type, the aerial vehicle, or the aerial vehicle device.

17. The one or more tangible, non-transitory computer-readable media of claim 15, further comprising:
obtaining, by the computing system, an elapsed time indicative of a time period after the routing request is provided and before an acknowledgement is received from the aerial vehicle device; and
in response to the elapsed time achieving the time threshold, initiating, by the computing system, the retry action.

18. A computing system comprising:
one or more processors; and
one or more tangible, non-transitory, computer readable media that store instructions that when executed by the one or more processors cause the computing system to perform operations, the operations comprising:
obtaining routing data for an aerial vehicle associated with an aerial vehicle device;
generating a routing request for the aerial vehicle based, at least in part, on the aerial vehicle device and the routing data;
determining an endpoint corresponding to the aerial vehicle device, wherein the endpoint is one of a plurality of endpoints of a vehicle integration interface associated with a service entity, the vehicle integration interface configured to connect with the plurality of endpoints; and
providing, via the endpoint of the vehicle integration interface, the routing request to the aerial vehicle device.

19. The computing system of claim 18, wherein generating the routing request comprises:
obtaining a vehicle model corresponding to the aerial vehicle, wherein the vehicle model comprises vehicle data for the aerial vehicle in a device agnostic format; and
generating the routing request based, at least in part, on the vehicle model.

20. The computing system of claim 19, wherein the vehicle model is updated based, at least in part, on telemetry data received, via the endpoint of the vehicle integration interface, from the aerial vehicle device.
